(19) United States
(12) Patent Application Publication
(10) Pub. No.: US 2011/0048027 A1
(43) Pub. Date: Mar. 3, 2011

(54) Turbine Driven By Predetermined Deflagration Of Anaerobic Fuel And Method Thereof

(76) Inventor: Joshua Waldhorn, Kfar Shmariyahu (IL)

(21) Appl. No.: 12/990,710

(22) PCT Filed: May 5, 2008
(86) PCT No.: PCT/IL08/00609

§ 371 Date: Nov. 2, 2010

(51) Int. Cl. F02C 3/20; F02C 7/26

(52) U.S. Cl. 60/776; 60/39.461; 60/786

(57) ABSTRACT

The present invention discloses a turbine assembly (20b) driven by predetermined deflagration of anaerobic fuel. The use of anaerobic fuel enables operation without any necessity for an additional oxidant, and leads to more efficient and environmentally friendly turbine operation. In addition, the gaseous products of the deflagration can be used for any number of purposes after they have passed through the turbine, e.g. combustion of the inflammable portion can drive a second turbine stage (214, 216) or be used to heat air or water.

### FIELD OF THE INVENTION

The present invention generally relates to gas-driven turbines, and particularly turbines actuated by gases produced by predetermined deflagration of anaerobic fuels.

### BACKGROUND

A turbine is a machine that converts the kinetic energy of a moving fluid to mechanical power by the impulse provided by the fluid to a series of blades, buckets, or paddles arrayed about the circumference of a central cylinder, wheel, or shaft. The first practical turbine (which used water as the fluid) was invented some 180 years ago, and since then, turbines have found uses in a variety of applications from electrical power production to propulsion systems for any size of vessels, tanks, jet airplanes and the space shuttle.

In most turbines in use today, the working fluid is a gas. In the vast majority of these cases, the flow of gas is provided by combustion of an appropriate fuel. The combustion of the fuel yields gaseous products, and the expansion of these gaseous products into the region of the turbine provides the impulse to the rotors of the turbine; the turbine is provided with an exhaust which allows the gases to flow from the region where they are formed at high pressure to a region of lower pressure, normally the atmosphere.

Although turbines are widely used, their use is not entirely unproblematic. For example, even the highest efficiency turbines used in the production of electrical power are only able to convert 30-40% of the thermal energy of the fuel into mechanical energy, the rest of the fuel's energy being lost as waste heat. The efficiency of such turbines is further limited by the high temperatures at which they run, which cause the air within to expand and the pressure to be lowered. Furthermore, because of these high combustion temperatures, and because the fossil fuels that are commonly combusted frequently contain sulfur-containing impurities, gas turbines frequently produce environmentally unfriendly and undesired NOₓ and SOₓ gases as side products.

Several inventions have been disclosed that attempt to remedy one or more of these difficulties. For example, U.S. Pat. No. 5,161,377 discloses a method for generating energy using a BLEVE (Boiling Liquid Expanding Vapor Explosion) reaction wherein a superheated liquid gas is passed into a reaction chamber where nucleation cores are formed, followed by the explosion of the superheated liquid gas. By driving a turbine from the explosion of the superheated liquid gas and subsequently recondensing the gas, the thermal efficiency of the overall system (including the use of the fuel used to superheat the liquid) is increased relative to a regular gas turbine.

Another approach to improving the overall efficiency of a turbine has been to use shaped charges, as disclosed, for example, in U.S. Pat. No. 6,658,838. By shaping the charge of the fuel, the expansion of the gases produced by its combustion can be more precisely controlled, and greater efficiency obtained.

Yet a third approach taken has been the development of pulse detonation systems for turbines. In a pulse detonation system, for example, as disclosed in U.S. Pat. Nos. 6,868,655; 6,883,302; and 6,981,361, a greater than stoichiometric (fuel-rich) fuel/air mixture is introduced into a deflagration chamber. This mixture is then detonated. Following this initial detonation, additional fuel and air are then introduced into the combustion chamber and ignited in a second combustion step. This type of turbine system is particularly useful in the engines of supersonic jet airplanes, where the detonation provides additional impulse to the rotor blades and hence increased engine thrust.

Another means for improving the efficiency of turbine systems has been to provide a multiple-stage turbine system. Many variations on this concept have been developed, e.g. as disclosed in U.S. Pat. Nos. 3,086,362; 4,424,668; 4,519,207; 4,631,915; 4,831,817; and 5,365,730. All of these inventions teach a similar basic concept for the turbine system. The first turbine stage is a standard gas turbine. The waste heat from the gas turbine is then used to heat water to produce steam or superheated steam, which is then used to drive a second turbine. In some cases, yet an additional stage can be added to the multiple stage system.

Despite their wide use, all of these methods have several fundamental limitations. First, they all still rely on the combustion, detonation, or explosion of a fuel/air mixture, and hence rely on a source of air or other oxidant in addition to the fuel itself and cannot be free of the problems described above. Furthermore, because they utilize oxidation of an inflammable fuel, the efficiency of these methods is limited (generally to no more than ˜30%) by the inevitable production of large amounts of waste heat, and the efficiency of the turbine decreases sharply as the ambient temperature increases. In addition, these methods tend to produce copious amounts of pollutants such as SOₓ and NOₓ either due to combustion of impurities in the fuel or due to direct combustion of atmospheric nitrogen at their high operating temperatures.

Recently, a family of novel anaerobic fuels, including W.J.Fuel™, W.J.Ideal Fuel™, W.J.Explofuel™, and W.J.Chimofuel™ was presented. These fuels are useful for anaerobic reciprocation of a newly developed internal piston engine called W.J.Engine™ and/or W.J.Ideal Engine™. Similarly, a new storage system for the new anaerobic fuel (commercially available as W.J.Container™) was also presented. These fuels and engines are defined in PCT patent application PCT/IL2007/000185, which is hereby incorporated by reference. These fuels do not require any additional oxidant; under the conditions of use, they auto-oxidize via deflagration. A much higher percentage of the internal energy of the fuel is converted into expansion of the gases produced by this predetermined fully controlled deflagration than is the case with combustion of standard fuels. In addition, this predetermined fully controlled deflagration of these fuels produces only ppm of NOₓ, and zero SOₓ.

The prior art contains a number of examples of the use of anaerobic fuels (also known as “monofuels” or “monopropellants”), in turbine assemblies, most of which date from the early years of development of jet engine technology. The majority of these patents (e.g., U.S. Pat. Nos. 2,643,015; 2,775,865; 2,775,866; 2,858,670; 3,095,795; 3,128,706; 4,033,115; 4,092,824) use detonation of a non-aerobic fuel to start a turbine. These patents do not use the anaerobic fuel to run the turbine after it has started; and many of them introduce air into the combustion chamber despite the “anaerobic” nature of the fuel; and in most of these patents, the anaerobic fuel is a peroxide, with the patents specifically teaching against use of nitrogen-containing fuels of the W.J.Fuel™ type. U.S. Pat. Nos. 2,559,071; 3,030,771; and 3,452,828 do teach the use of an anaerobic fuel to drive a turbine, but in all cases, the anaerobic fuel is used in a secondary or tertiary turbine phase, rather than directly powering the main turbine.

Thus, there is a long-felt need for a system for driving a turbine in which no external oxidant is needed; in which the turbine is driven continuously and primarily by a fuel that does not need additional oxidant; for one in which conversion of the internal energy of the fuel to power occurs with high efficiency and with a minimum of waste heat; one that can work at any altitude; and for one that minimizes production of environmentally unfriendly byproducts such as NOₓ and SOₓ. The present invention provides a single apparatus and method that accomplishes all of these goals.

### SUMMARY OF THE INVENTION

The present invention provides solution to the problems outlined above by providing a turbine driven by predetermined deflagration of an anaerobic fuel, and a method for its use.

It is therefore an object of the current invention to provide a turbine assembly, comprising (a) a turbine; (b) means for supplying gas at higher than ambient pressure to one end of said turbine; and (c) means for exhausting gas from said turbine, located at the end of said turbine opposite to said one end, said means for exhausting gas being in communication with a region at or below ambient pressure. It is within the essence of the invention wherein said gas at higher than ambient pressure is provided by predetermined deflagration of anaerobic fuel.

It is a further object of the current invention to provide such a turbine assembly, further comprising a housing comprising a multiplicity of chambers and wherein said turbine comprises (a) a shaft contained within one of said chambers within said housing and (b) a rotor assembly supported by said shaft, located within said chamber containing said shaft; said means for supplying gas at higher than ambient pressure to one end of said turbine comprises (a) at least one deflagration chamber located within said housing, in communication with said chamber in which said shaft and said at least one rotor are located such that gas may pass freely between said deflagration chambers and said shaft and said at least one rotor are located, (b) at least one storage unit for anaerobic fuel, (c) means for conveying anaerobic fuel from said at least one storage unit to said at least one deflagration chamber, and (d) means for igniting said anaerobic fuel within said at least one deflagration chamber; said means for exhausting gases from said turbine are in communication with said chamber containing said shaft and said at least one rotor; and further wherein rotation of said rotor assembly is driven by motion of gases produced by a predetermined deflagration of said anaerobic fuel from said deflagration chamber to said exhaust.

It is a further object of the current invention to provide such a turbine assembly, said rotor assembly being chosen from the group consisting of (a) at least one rotor rotatably supported by said shaft such that each one of said at least one rotors is able to rotate freely and independently; (b) a plurality of rotors rotatably supported by said shaft and configured such that successive rotors rotate in opposite directions; (c) at least one rotor non-rotatably supported by said shaft, said shaft adapted to rotate relative to said rotor assembly chamber; (d) said shaft constructed sectionally such that at least one section is adapted to rotate about its axis relative to said rotor assembly chamber; at least one rotor rotatably supported by said shaft such that each one of said at least one rotors is able to rotate freely and independently; and at least one rotor non-rotatably supported by said shaft, configured such that each of said at least one non-rotatable rotors is supported by said section of said shaft adapted to rotate relative to said rotor assembly chamber; (e) at least one rotor rotatably supported by said shaft and at least one stator supported by said shaft, configured such that said at least one rotor and said at least one stator are arranged alternately along the shaft; and (f) said shaft constructed sectionally such that at least one section is adapted to rotate about its axis relative to said rotor assembly chamber; at least one rotor rotatably supported by said shaft; at least one rotor non-rotatably supported by said shaft; and at least one stator supported by said shaft, configured such that said at least one rotor and said at least one stator are arranged alternately along the shaft, and further configured such that each of said at least one non-rotatable rotors is supported by said section of said shaft adapted to rotate relative to said rotor assembly chamber.

It is a further object of the current invention to provide such a turbine assembly, the storage unit for said anaerobic fuel comprising a fuel storage container, e.g., the commercially available W.J.Container™, with characteristics chosen from the group consisting of (a) isolated against heat, static electricity, sparks, lightning, fire, shock, water, shock waves; (b) fully armor protected against light fire arms and/or RPGs; (c) provided with self-cooling and dry-air systems adapted to keep said stored anaerobic fuel at a temperature of not more than about 35° C. and not less than about −20° C.; (d) storable in vacuum conditions; and further wherein said storage unit is characterized by a container-within-a-container arrangement.

It is a further object of the current invention to provide such a turbine assembly, said means for conveying said anaerobic fuel to said deflagration chamber comprising (a) means for connecting said storage unit to said deflagration chamber, said means chosen from the group consisting of tube, pipe, conveyor belt, linear table, screw, plurality of screws, servomotors, pumps, vibrating tables, shaking conveyors, magnets, or any other means for connecting a storage unit for a solid to an enclosed location external to said storage unit; (b) means for extracting a predetermined quantity of fuel from said storage unit; (c) means for enabling physical transfer and feeding of said quantity of fuel from said storage unit to said deflagration chamber; and (d) an isolation valve separating said deflagration chamber from said storage unit, said valve being actuated electrically and/or pneumatically and/or hydraulically and/or mechanically; wherein said fuel is safely and accurately conveyed from said storage unit to said deflagration chamber.

It is a further object of the current invention to provide such a turbine assembly, further comprising means for directing gases formed in the deflagration directly toward said rotor assembly.

It is a further object of the current invention to provide such a turbine assembly, further comprising means for combusting flammable gases, adapted for combusting flammable gases emitted via said exhaust means.

It is a further object of the current invention to provide such a turbine assembly, further comprising a heat exchanger adapted to heat exchange between said means for combusting inflammable gases and a means for accepting heat transferred from said means for combusting inflammable gases.

It is a further object of the current invention to provide such a turbine assembly, further comprising a second stage, said second stage comprising (a) an entrance, said entrance communicating with said exhaust means such that gases may freely flow from said exhaust means to said entrance; (b) an oxidation chamber communicating with said entrance such that gases may freely flow from said entrance into said oxidation chamber; (c) means for introducing an oxidant into said oxidation chamber; (d) means for igniting inflammable gases located inside said oxidation chamber; (e) a second-stage turbine chamber in communication with said oxidation chamber such that gases may freely flow from said oxidation chamber to said second-stage turbine chamber; (f) a second-stage shaft located within said second-stage turbine chamber; (g) a second-stage rotor assembly supported by said second-stage shaft; and (h) a means for exhausting gases from said second stage, said means for exhausting gases from said second stage communicating with said second-stage turbine chamber such that gases may freely flow from said second-stage turbine chamber to said means for exhausting gases from said second stage. It is in the essence of the current invention wherein the propulsive force for rotation of the blades of the second-stage rotor assembly is provided by expansion of gases created during combustion of inflammable components of said exhaust gases.

It is a further object of the current invention to provide such a turbine assembly, in which the turbine assembly further comprises a second stage, said second stage comprising (a) an entrance, said entrance communicating with said exhaust means such that gases may freely flow from said second stage exhaust means to said entrance; (b) an oxidation chamber communicating with said entrance such that gases may freely flow from said entrance into said oxidation chamber; (c) means for introducing an oxidant into said oxidation chamber; (d) means for combusting inflammable gases located inside said oxidation chamber; (e) a source of water; (f) means for transferring heat from said oxidation chamber to water derived from said source; and, (g) a second-stage turbine chamber containing a steam turbine in communication with said source of water. It is within the essence of the current invention wherein heat generated by combustion of said inflammable gases converts said water to steam and/or superheated steam, and further wherein said steam turbine is driven by said steam and/or superheated steam.

It is a further object of the current invention to provide such a two-stage turbine assembly, in which the assembly further comprises (a) a condenser in communication with said steam turbine, and (b) means for transferring liquid water produced by said condenser to said source of water. It is in the essence of the invention wherein steam exiting said steam turbine is condensed to liquid water in said condenser, and further wherein said water runs from said source through said turbine and said condenser back to said source in a closed loop.

It is a further object of the current invention to provide a turbine assembly in which said gas at higher than ambient pressure is provided by predetermined deflagration of anaerobic fuel and further comprising a means for diverting exhaust gases from said turbine through a closed channel, said closed channel being in thermal contact with a heat exchanger adapted for heating or cooling large volumes or areas.

It is a further object of the current invention to provide a turbine assembly in which said anaerobic fuel is a chemical fuel and/or propellant.

It is a further object of the current invention to provide such a turbine assembly, wherein said chemical fuel is selected from the group consisting of RDX (C₃H₆N₆O₆), TNT (CH₃C₆H₂(NO₂)₃), HMX, nitrocellulose, cellulose, and nitroglycerin.

It is a further object of the current invention to provide such a turbine assembly in which said propellant is selected from a group containing compositions of sulfur, ammonium nitrate, ammonium picrate, aluminum powder, potassium chlorate, potassium nitrate (saltpeter), nitrocellulose, pentaerythiotol tetranitrate (PETN), CGDN, 2,4,6 trinitrophenyl methylamine (tetryl) and other booster explosives, a mixture of about 97.5% RDX, about 1.5% calcium stearate, about 0.5% polyisobutylene, and about 0.5% graphite (CH-6), a mixture of about 98.5% RDX and about 1.5% stearic acid (A-5), cyclotetramethylene tetranitramine (HMX), octogen-octahydro-1,3,5,7 tetranitro 1.3.5.7. tetrazocine, cyclic nitramine 2,4,6,8,10,12-hexanitro-2,4,6,8,10,12-hexaazaisowurtzitane (CL-20), 2,4,6,8,10,12-hexanitrohexaazaisowurtzitan (HNIW), 5-cyanotetrazolpentaamine cobalt III perchlorate (CP), cyclotrimethylene trinitramine (RDX), triazidotrinitrobenzene (TATNB), tetracence, smokeless powder, black powder, boracitol, triamino trinitrobenzene (TATB), TATB/DATB mixtures, triethylene glycol dinitrate (TEGDN), tertyl, trimethyleneolethane trinitrate (TMETM), trinitroazetidine (TNAZ), sodium azide, nitrogen gas, potassium oxide, sodium oxide, silicon dioxide, alkaline silicate, salt, saltwater, water from any manmade or natural body of water, diphenylamine, dyestuffs, cellulose, wood, fusel oil, acetobacteria, algae, or any combination thereof.

It is a further object of the current invention to provide such a turbine assembly in which said anaerobic fuel comprises at least two components, and further wherein said deflagration chamber is adapted for in situ preparation of anaerobic fuel from said components.

It is a further object of the current invention to provide such a turbine assembly in which said anaerobic fuel is adapted to provide multiple independent deflagrations from each quantity of fuel conveyed to said deflagration chamber.

It is a further object of the current invention to provide such a turbine assembly in which said anaerobic fuel is in pellet form, and further wherein each pellet comprises a plurality of layers of said anaerobic fuel.

It is a further object of the current invention to provide such a turbine assembly in which said anaerobic fuel is in capsule form, and further wherein each capsule comprises a plurality of smaller capsules, and further wherein each of said smaller capsules contains a predetermined quantity of said anaerobic fuel.

It is a further object of the current invention to provide such a turbine assembly in which said anaerobic fuel is supplied in a form chosen from the group consisting of solid, gel, flakes, liquid, fluid, powders in any size and shape, and any combination thereof, and further wherein each element of the combination contains a predetermined quantity of the anaerobic fuel.

It is a further object of the current invention to provide such a turbine assembly in which said means for igniting said anaerobic fuel is chosen from the group consisting of (a) an electric spark; (b) a heating plug or apparatus; (c) a plasma plug; and (d) any other method to ignite, heat, or warm said anaerobic fuel.

It is a further object of the current invention to provide such a turbine assembly, further comprising means for conveying, igniting and deflagrating said anaerobic fuel according to a predetermined sequence.

It is a further object of the current invention to provide such a turbine assembly in which said predetermined sequence is adapted to allow conveyance, ignition, and deflagration of a quantity of said anaerobic fuel while deflagration of a second quantity of said anaerobic fuel is taking place.

It is a further object of the current invention to provide such a turbine assembly, additionally comprising a pressure relief valve adapted to open when the gas pressure inside the deflagration chamber exceeds a predetermined value.

It is a further object of the current invention to provide such a turbine assembly, adapted for any of the following uses: (a) generation of electrical energy; (b) use in a power generation plant; (c) providing propulsion for any kind of airplane; (d) providing propulsion for any type, size or shape of drone craft; (e) providing propulsion for any type, size, or shape of space-going craft; (f) providing propulsion to any type, size or shape of motor vehicle, said motor vehicle chosen from the group consisting of automobile, van, pickup truck, sport-utility vehicle, bus, truck, and any other wheeled vehicle used for ground transportation; (g) providing propulsion to any type, size or shape of boat and/or ship; (h) providing propulsion to a hovercraft; (i) providing propulsion to any type, size or shape of locomotive whether operated above ground or underground; (j) providing propulsion to a motorcycle, motorized bicycle, motorized tricycle, or motorized cart; (k) providing propulsion to any type, size or shape of tank or other armored vehicle; (l) providing propulsion to any type, size or shape of agricultural vehicle chosen in a non-limiting manner from the group consisting of thresher, reaper, combine harvester, tractor, and any other vehicle adapted for use in agriculture; (m) providing electric energy to a manufactured article such as a laptop computer, (n) generation of electrical energy to any type, size or shape of electric motor, (o) powering any type, size or shape of micro-turbine (p) powering any type, size or shape of nano-turbine as a motor used to drive any nano-scale machine that needs a rotating shaft; (q) powering any type or size of mechanical pump.

It is a further object of the current invention to provide a method for using anaerobic fuel to drive a turbine, said method comprising the steps of (a) obtaining anaerobic fuel; (b) transferring a predetermined quantity of said anaerobic fuel to at least one deflagration chamber; (c) igniting and deflagrating said predetermined quantity of said anaerobic fuel within said deflagration chamber; (d) expanding gases produced by said deflagration expand into a second chamber, said second chamber containing a shaft and a rotor assembly supported by said shaft; (e) exhausting gases from said second chamber; (f) repeating steps (b) through (e); wherein expansion of gases produced by predetermined deflagration of said anaerobic fuel is used to drive said set of rotor assembly.

It is a further object of the current invention to provide such a method, further comprising the step of combusting inflammable gases present in said gas exhausted from said second chamber.

It is a further object of the current invention to provide such a method, said method comprising the steps of (a) obtaining anaerobic fuel; (b) transferring a predetermined quantity of said anaerobic fuel to at least one deflagration chamber according to a predetermined sequence; (c) igniting and deflagrating said predetermined quantity of said anaerobic fuel within said deflagration chamber according to a predetermined protocol; (d) allowing gases produced by said deflagration to expand into a second chamber, said second chamber containing a shaft and a rotor assembly; (e) exhausting gases from said second chamber; and repeating steps (b) through (e). It is within the essence of the invention wherein expansion of gases produced by predetermined deflagration of said anaerobic fuel is used to drive said rotor assembly.

It is a further object of the current invention to provide a method for using anaerobic fuel to drive a multi-stage turbine, said method comprising the steps of (a) obtaining anaerobic fuel; (b) transferring a predetermined quantity of said anaerobic fuel to at least one deflagration chamber; (c) igniting and deflagrating said predetermined quantity of said anaerobic fuel within said deflagration chamber; (d) allowing gases produced by said deflagration to expand into a first-stage turbine chamber, said first-stage turbine chamber containing a first-stage shaft and a first-stage rotor assembly supported by said first-stage shaft; (e) exhausting gases from said first-stage turbine chamber; (f) allowing said gases exhausted from said first-stage turbine chamber to flow into an oxidation chamber; (g) allowing an oxidant to flow into said oxidation chamber contemporaneously with the flow of said gases exhausted from said first-stage turbine chamber into said oxidation chamber; (h) combusting inflammable gases contained within said gases exhausted from said first-stage turbine chamber in said oxidation chamber; (i) allowing gases to flow from said oxidation chamber to a second-stage turbine chamber, said second-stage turbine chamber containing a second-stage shaft and a second-stage rotor assembly supported by said shaft; and (j) repeating steps (b) through (i). It is within the essence of the invention wherein expansion of gases produced by predetermined deflagration of said anaerobic fuel is used to drive said first-stage rotor assembly, and further wherein expansion of gases produced by combustion in said oxidation chamber is used to drive said second-stage rotor assembly.

It is a further object of the current invention to provide a method for using anaerobic fuel to drive a multi-stage turbine, said method comprising the steps of (a) obtaining anaerobic fuel; (b) transferring a predetermined quantity of said anaerobic fuel to at least one deflagration chamber; (c) igniting and deflagrating said predetermined quantity of said anaerobic fuel within said deflagration chamber; (d) allowing gases produced by said deflagration to expand into a first-stage turbine chamber, said first-stage turbine chamber containing a first-stage shaft and a first-stage rotor assembly supported by said first-stage shaft; (e) exhausting gases from said first-stage turbine chamber; (f) allowing said gases exhausted from said first-stage turbine chamber to flow into an oxidation chamber; (g) allowing an oxidant to flow into said oxidation chamber contemporaneously with the flow of said gases exhausted from said first-stage turbine chamber into said oxidation chamber; (h) combusting inflammable gases contained within said gases exhausted from said first-stage turbine chamber in said oxidation chamber; (i) obtaining liquid water; (j) using heat generated by said combusting of said inflammable gases to heat said water to steam and/or superheated steam; (k) using said steam and/or superheated steam to drive a second-stage steam turbine; and, (l) repeating steps (b) through (k). It is within the essence of the invention wherein expansion of gases produced by predetermined deflagration of said anaerobic fuel is used to drive said first-stage rotor assembly, and further wherein combustion in said oxidation chamber is used to heat water to steam and/or superheated steam, and further wherein said steam and/or superheated steam is used to drive said second-stage steam turbine.

It is a further object of the invention to provide such a method, further comprising the steps of: (a) allowing steam and/or superheated steam exiting the steam turbine to flow into a condenser; (b) condensing said steam and/or superheated steam to liquid water; and (c) using said condensate as said liquid water. It is within the essence of the invention wherein said water is used in a closed cycle.

It is a further object of the current invention to provide a method for generating energy utilizing the deflagration of an anaerobic fuel, comprising the steps of (a) obtaining anaerobic fuel; (b) introducing said anaerobic fuel into a deflagration chamber; (c) igniting and deflagrating said anaerobic fuel within said deflagration chamber; and (d) discharging gases formed during the deflagration of said anaerobic fuel across an energy-generating machine. It is within the essence of the invention wherein said energy-generating machine is driven by said gases produced in said deflagration.

It is a further object of the current invention to provide a method for generating energy utilizing the deflagration of an anaerobic fuel, comprising the steps of (a) obtaining anaerobic fuel; (b) introducing said anaerobic fuel into a deflagration chamber; (c) igniting and deflagrating said anaerobic fuel within said deflagration chamber; (d) discharging gases formed during the deflagration of said anaerobic fuel across a first energy-generating machine; (e) allowing gases to flow from the exhaust of said first energy-generating machine to an oxidation chamber; (f) flowing an oxidant into said oxidation chamber contemporaneously with said flow of exhaust gases; (g) combusting the inflammable portion of said exhaust gases in said oxidation chamber; (h) discharging gases present in said oxidation chamber after combustion of said inflammable portion of said exhaust gases across a second energy-generating machine; (i) repeating steps (b) through (h). It is within the essence of the invention wherein said first energy-generating machine is driven by said gases produced in said deflagration, and further wherein said second energy-generating machine is driven by gases discharged from said oxidation chamber.

It is a further object of the current invention to provide such a method, in which the step of obtaining anaerobic fuel further comprises the step of obtaining anaerobic fuel chosen from the group consisting of chemical fuel and propellant.

It is a further object of the current invention to provide such a method, in which the step of obtaining anaerobic fuel further comprises the step of obtaining chemical fuel selected from the group consisting of RDX (C₃H₆N₆O₆), TNT (CH₃C₆H₂(NO₂)₃), HMX, cellulose, nitrocellulose, nitroglycerin, diphenylamine, dyestuffs, and any combination thereof.

It is a further object of the current invention to provide such a method, in which the step of obtaining anaerobic fuel further comprises the step of obtaining a propellant selected from the group containing compositions of compositions of sulfur, ammonium nitrate, ammonium picrate, aluminum powder, potassium chlorate, potassium nitrate (saltpeter), nitrocellulose, pentaerythiotol tetranitrate (PETN), CGDN, 2,4,6 trinitrophenyl methylamine (tetryl) and other booster explosives, a mixture of about 97.5% RDX, about 1.5% calcium stearate, about 0.5% polyisobutylene, and about 0.5% graphite (CH-6), a mixture of about 98.5% RDX and about 1.5% stearic acid (A-5), cyclotetramethylene tetranitramine (HMX), octogen-octahydro-1,3,5,7 tetranitro 1.3.5.7. tetrazocine, cyclic nitramine 2,4,6,8,10,12-hexanitro-2,4,6,8,10,12-hexaazaisowurtzitane (CL-20), 2,4,6,8,10,12-hexanitrohexaazaisowurtzitan (HNIW), 5-cyanotetrazolpentaamine cobalt III perchlorate (CP), cyclotrimethylene trinitramine (RDX), triazidotrinitrobenzene (TATNB), tetracence, smokeless powder, black powder, boracitol, triamino trinitrobenzene (TATB), TATB/DATB mixtures, triethylene glycol dinitrate (TEGDN), tertyl, trimethyleneolethane trinitrate (TMETM), trinitroazetidine (TNAZ), sodium azide, nitrogen gas, potassium oxide, sodium oxide, silicon dioxide, alkaline silicate, salt, saltwater, water from any manmade or natural body of water, diphenylamine, dyestuffs, cellulose, wood, fusel oil, acetobacteria, algae, or any combination thereof.

It is a further object of the current invention to provide a method for adapting an existing turbine assembly for use with anaerobic fuel, said method comprising the steps of (a) obtaining a turbine assembly, said turbine assembly comprising a combustion chamber, means for introducing fuel and oxidant into said combustion chamber, and a rotor assembly; (b) replacing the combustion chamber with a deflagration chamber; (c) removing the means for providing oxidant to the combustion chamber; (d) calculating the number of blades and/or rows of blades to be removed from the rotor assembly such that the total power output after the adaptation will match a predetermined value; (e) removing a number of blades and/or rows of blades from said rotor assembly according to the calculation performed in step (d); and (f) replacing the means for supplying fuel with means for supplying anaerobic fuel. It is within the essence of the invention wherein the adapted turbine assembly is driven by the predetermined deflagration of anaerobic fuel.

### BRIEF DESCRIPTION OF THE FIGURES

FIG. 1 shows a schematic drawing of the essential features of the invention.

FIG. 2 shows an assembly drawing (not to scale) of a preferred embodiment of the invention.

FIG. 3 shows an assembly drawing (not to scale) of an additional embodiment of the invention, comprising two deflagration chambers.

FIG. 4 shows an assembly drawing (not to scale) of an additional embodiment of the invention, additionally comprising a second-stage turbine.

FIG. 5 shows an assembly drawing (not to scale) of an additional embodiment of the invention, additionally comprising a second-stage turbine and a heat exchanger.

FIG. 6 shows an assembly drawing (not to scale) of an additional embodiment of the invention, in which the exhaust gases from the turbine assembly are sent directly to a heat exchanger.

FIG. 7 shows an assembly drawing (not to scale) of an additional embodiment of the invention, in which the anaerobic fuel is created in situ in the deflagration chamber from multiple components.

FIG. 8 shows an assembly drawing (not to scale) of an additional embodiment of the invention, in which the turbine assembly is adapted for use in a jet engine.

### DETAILED DESCRIPTION OF THE INVENTION

It will be apparent to one skilled in the art that there are several embodiments of the invention that differ in details of construction, without affecting the essential nature thereof, and therefore the invention is not limited by that which is illustrated in the figures and described in the specification, but only as indicated in the accompanying claims, with the proper scope determined only by the broadest interpretation of said claims.

As used hereinafter, the term “rotor” refers to a plurality of blades attached to the outer surface of a ring, along the ring's circumference, the assembly designed to be supported by a shaft passing through the center of the ring. Unless specifically described otherwise, the assembly is supported rotatably by the shaft, e.g. by a bearing.

As used hereinafter, the term “stator” refers to refers to a plurality of blades attached to the outer surface of a ring, along the ring's circumference, the assembly designed to be supported by a shaft passing through the center of the ring, in such a manner that the stator cannot rotate.

As used hereinafter, the term “predetermined deflagration” refers in a non-limiting manner to a method for controlling the deflagration of a solid non-aerobic fuel by controlling the size, composition, and geometry of the fuel pieces in order to produce a desired rate of fuel deflagration and in order to produce a pressure wave with a desired set of properties, said pressure wave originating from the gases produced by the deflagration of the fuel.

As used hereinafter, the term “anaerobic fuel” refers to any AIP predetermined deflagrated materials and predetermined combustible material or propellant composition which requires no extra oxygen to produce a hot mass of gases. The term alternatively refers to commercially available W.J.Fuel™ and or W.J.Explofuel™ and or W.J.Chimofuel™ propellants. The term is especially related to anaerobic fuels and W.J.Explofuel™ propellants selected from smokeless powder, e.g., nitrocellulose or the like, single-base propellant and or powders, powders combined with up to 50 percent nitroglycerin or the like, double-base propellants and/or powders, nitroglycerin and nitroguanidine or the like (triple-base) or any combination thereof. The term is also related to anaerobic fuels and W.J.Fuel™ and or W.J.Explofuel™ and or W.J.Chimofuel™ propellants comprising stabilizers and/or ballistic modifiers. The term is also related to chemo-fuels of any kind or type, which fuels can be in the form of gel, liquid, solid, flakes, powder, fine particles, cake or any flowing matter.

The fuel comprises a chemical fuel, in a form chosen from the group that consists of small pellets, liquid, solid flowing materials, gel, flakes, powder, and droplets or any combination thereof. Said chemical fuel is chemical fuel selected from the group consisting of RDX (C₃H₆N₆O₆), TNT (CH₃C₆H₂(NO₂)₃), HMX, cellulose, nitrocellulose, nitroglycerin, diphenylamine, dyestuffs, and any combination thereof, according to the specific embodiment of the invention. Additionally, and still in a non-limiting manner, the aforesaid anaerobic fuel comprises a propellant selected from a group including inter alia compositions of sulfur, ammonium nitrate, ammonium picrate, aluminum powder, potassium chlorate, potassium nitrate (saltpeter), nitrocellulose, pentaerythiotol tetranitrate (PETN), CGDN, 2,4,6 trinitrophenyl methylamine (tetryl) and other booster explosives, a mixture of about 97.5% RDX, about 1.5% calcium stearate, about 0.5% polyisobutylene, and about 0.5% graphite (CH-6), a mixture of about 98.5% RDX and about 1.5% stearic acid (A-5), cyclotetramethylene tetranitramine (HMX), octogen-octahydro-1,3,5,7 tetranitro 1.3.5.7. tetrazocine, cyclic nitramine 2,4,6,8,10,12-hexanitro-2,4,6,8,10,12-hexaazaisowurtzitane (CL-20), 2,4,6,8,10,12-hexanitrohexaazaisowurtzitan (HNIW), 5-cyanotetrazolpentaamine cobalt III perchlorate (CP), cyclotrimethylene trinitramine (RDX), triazidotrinitrobenzene (TATNB), tetracence, smokeless powder, black powder, boracitol, triamino trinitrobenzene (TATB), TATB/DATB mixtures, triethylene glycol dinitrate (TEGDN), tertyl, trimethyleneolethane trinitrate (TMETM), trinitroazetidine (TNAZ), sodium azide, nitrogen gas, potassium oxide, sodium oxide, silicon dioxide, alkaline silicate, salt, saltwater, water from any manmade or natural body of water, diphenylamine, dyestuffs, cellulose, wood, fusel oil, acetobacteria, algae, or any combination thereof.

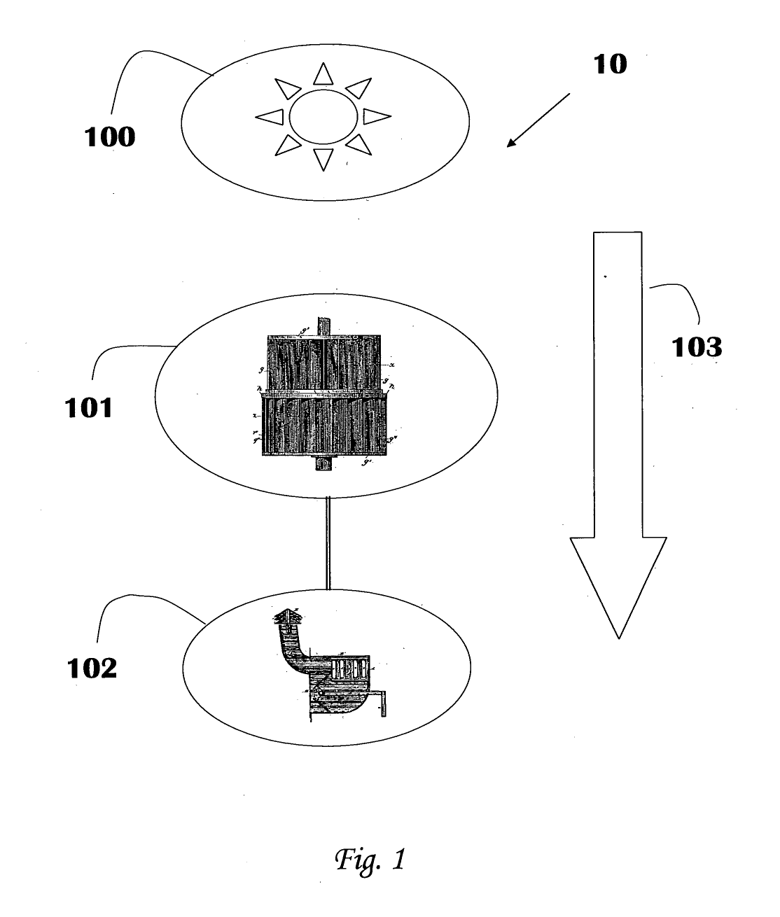

Reference is now made to FIG. 1, in which a schematic diagram of the operation of the turbine assembly (10) is presented. The basic assembly consists of three components: a deflagration chamber 100, a turbine assembly 101, and means for exhausting gases from the turbine assembly 102. A predetermined quantity of anaerobic fuel is introduced into the deflagration chamber, where it is ignited, and deflagration commences. The process of deflagration converts the solid fuel into a high-pressure mixture of gases. The deflagration chamber is in communication with one end of the turbine such that gases may flow from the deflagration chamber in the direction of the turbine; expansion of gases created by the deflagration drives the turbine. Means for exhausting gases to a region of lower pressure (e.g., to atmosphere) are provided so that pressure backup does not occur. The general direction of gas flow is indicated schematically by the arrow 103.

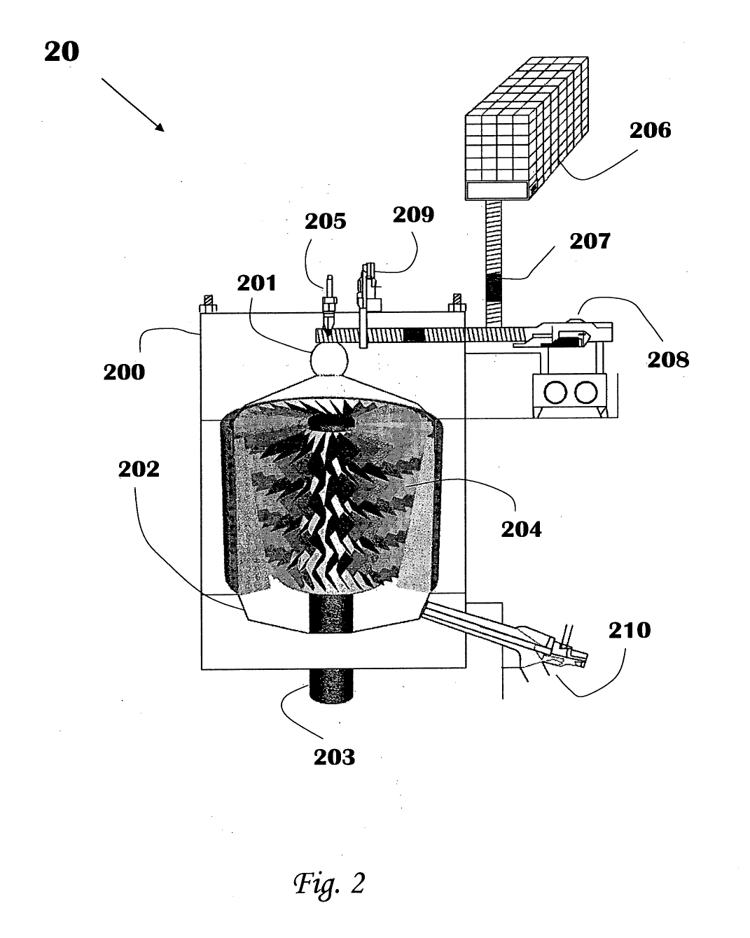

Reference is now made to FIG. 2, in which a schematic (not to scale) assembly drawing of a preferred embodiment 20 of the invention is shown. Anaerobic fuel is stored in a storage unit 206, and conveyed to the turbine assembly housing 200 via a transfer apparatus 207; means for extracting a predetermined amount of anaerobic fuel 208 are provided. The fuel is transferred from the container to a deflagration chamber 201 located within the turbine assembly housing. In the embodiment schematically illustrated in FIG. 2, a valve 209 isolates the deflagration chamber from the container and transfer apparatus. The valve is opened in order to admit fuel into the deflagration chamber and then closed prior to ignition of the fuel. An ignition apparatus 205 ignites the fuel within the deflagration chamber. The deflagration chamber is in communication with one end of a turbine chamber 202 such that gases may flow freely from the deflagration chamber into the turbine chamber. The turbine chamber contains a shaft 203 that supports a rotor assembly 204. The expansion of gases from the deflagration of the fuel drives the turbine. An exhaust apparatus 210 allows gases to escape from the turbine assembly housing.

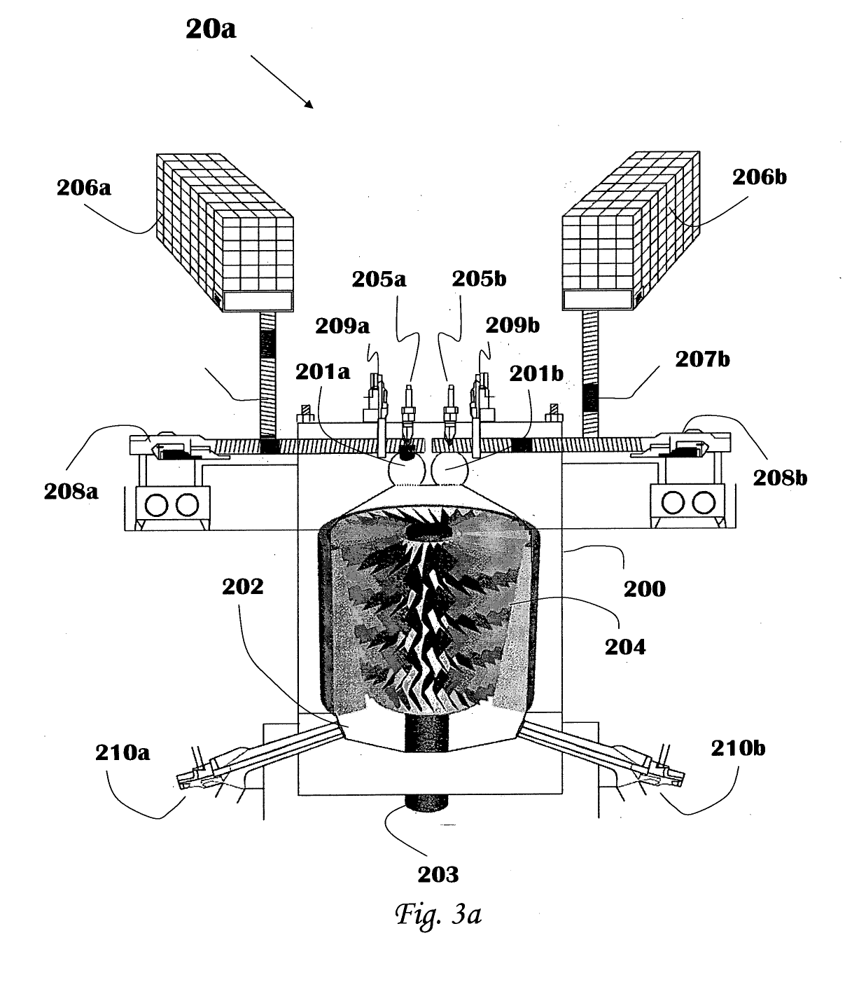

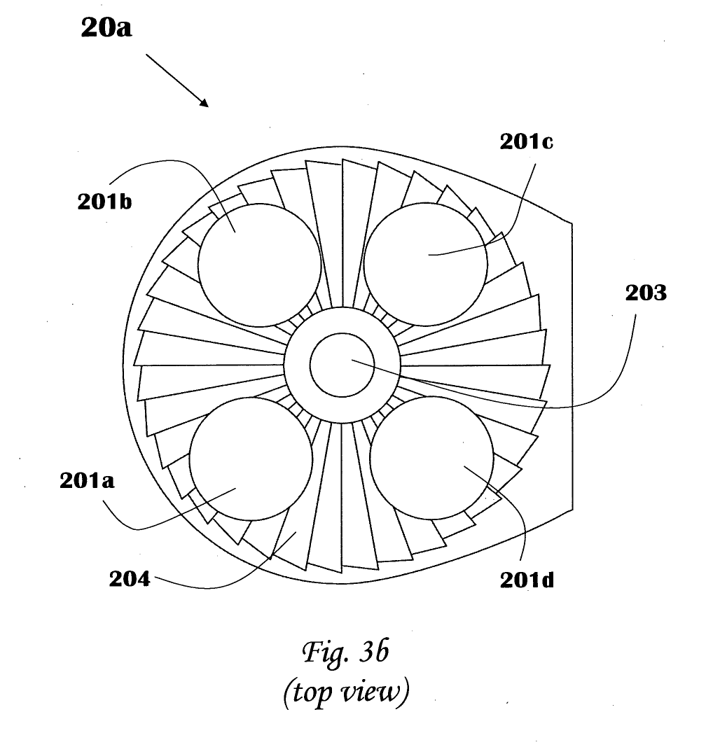

Reference is now made to the group FIG. 3, in which a schematic view (not to scale) of an alternative embodiment 20a is presented. This embodiment exemplifies, in a non-limiting manner, a turbine assembly with N independent deflagration chambers, where N is an integer greater than 1. In FIG. 3a, an embodiment illustrated with N=2; the two deflagration chambers are denoted 201a and 201b. In this particular embodiment, the anaerobic fuel is stored in two separate, independent storage units 206a and 206b, each of which is connected to the turbine assembly housing by an independent transfer unit (207a and 207b, respectively) and extraction means (208a and 208b, respectively). In the particular embodiment schematically illustrated in FIG. 3a, each of the two independent deflagration chambers is isolated by a valve (209a and 209b, respectively) from containers 206a and 206b; the two valves operate independently of one another. Each valve opens to admit fuel into the associated deflagration chamber and closes prior to ignition of the fuel in that chamber. Each deflagration chamber has an independent ignition system (205a and 205b, respectively) that enables ignition of the fuel independent of ignition and deflagration of fuel that is taking place in the other chamber. Each of the two deflagration chambers is in communication with one end of the (single) turbine chamber 202, which contains a shaft 203 and a rotor assembly 204 supported by the shaft, such that gases may flow freely from each deflagration chamber into the turbine chamber. As in the previous embodiment, the turbine is driven by expansion of gases created by the deflagration of the fuel. In the specific embodiment illustrated in FIG. 3a, gases are exhausted from the turbine chamber by two independent exhaust assemblies 210a and 210b. There is no necessary connection between the number of deflagration chambers and the number of exhaust assemblies, however; an embodiment with multiple deflagration chambers may have a single exhaust assembly, while an embodiment with a single deflagration chamber may have a plurality of exhaust assemblies. It is acknowledged and emphasized that the construction is not restricted to N 2; the invention revealed in the present disclosure can comprise any number of fuel storage units and deflagration chambers, depending on the particular construction requirements desired or required by the operator. For example, a top view of the rotor assembly (not to scale) is illustrated in FIG. 3b, showing the positions of the deflagration chambers relative to the shaft. In this case, N=4.

In alternative embodiments of the present invention, the rotor assembly may be chosen from the group consisting of (a) at least one rotor rotatably supported by the shaft such that each one of the rotors is able to rotate freely and independently; (b) a plurality of rotors rotatably supported by the shaft and configured such that successive rotors rotate in opposite directions; (c) at least one rotor rotatably supported by the shaft and at least one stator supported by the shaft, configured such that rotor(s) and stator(s) are arranged alternately along the shaft.

In a preferred embodiment of the invention, the storage unit for the anaerobic fuel comprises a container that is designed specifically for its storage. The container has a container-within-a-container arrangement, and furthermore has characteristics chosen from the group consisting of: (a) it isolates the fuel from at least one of heat, static electricity, sparks, lightning, fire, shock, water, and shock waves; (b) it is fully armor protected against light firearms and/or RPGs; (c) it is provided with self-cooling and dry-air systems adapted to keep the anaerobic fuel stored within at a temperature of not more than about 35° C. and not less than about −20° C.; and (d) it is storable in vacuum conditions.

In a preferred embodiment of the invention, the means for conveying the anaerobic fuel to the deflagration chamber comprise (a) means for connecting said storage unit to said deflagration chamber, said means chosen from the group consisting of tube, pipe, conveyor belt, linear table, screw, plurality of screws, servomotors, pumps, vibrating tables, shaking conveyors, magnets, or any other means for connecting a storage unit for a solid to an enclosed location external to said storage unit; (b) means for extracting a predetermined quantity of fuel from the storage unit; and (c) means for enabling physical transfer of said predetermined quantity of fuel from the storage unit to the deflagration chamber. The isolation valve that separates the deflagration chamber from the storage unit may be activated electrically and/or pneumatically and/or hydraulically and/or mechanically.

In an alternative embodiment of the invention, the means of communication between the deflagration chamber(s) and the turbine assembly chamber is designed such that the gases formed in the deflagration are directed directly toward the rotor assembly in order to increase the overall efficiency of the invention by limiting or eliminating motion of gases in directions that will not be useful in driving the turbine.

In the aforementioned PCT patent application PCT/IL2007/000185 (incorporated by reference), results of deflagration of a typical anaerobic fuel were presented. It was shown that CO and H₂ account for approximately half of the gases produced in the deflagration. These gases themselves have significant energy content. Thus, in alternative embodiments of the present invention, the overall efficiency of the invention is improved by making use of this energy content.

In an alternative embodiment of the invention, the gases exhausted from the turbine chamber are directed into an oxidation chamber, in which they are mixed with an appropriate oxidant, and the inflammable fraction combusted. In one embodiment of the invention, a heat exchanger is used to transfer the heat produced by this combustion to any device capable of accepting it directly.

In various alternative embodiments of the invention, combustion of the inflammable fraction of the gases exhausted from the first-stage rotor assembly is initiated by means chosen from the group consisting of a flame; an electric spark; a heating plug or apparatus; a plasma plug; or any other means for initiating combustion of inflammable gases.

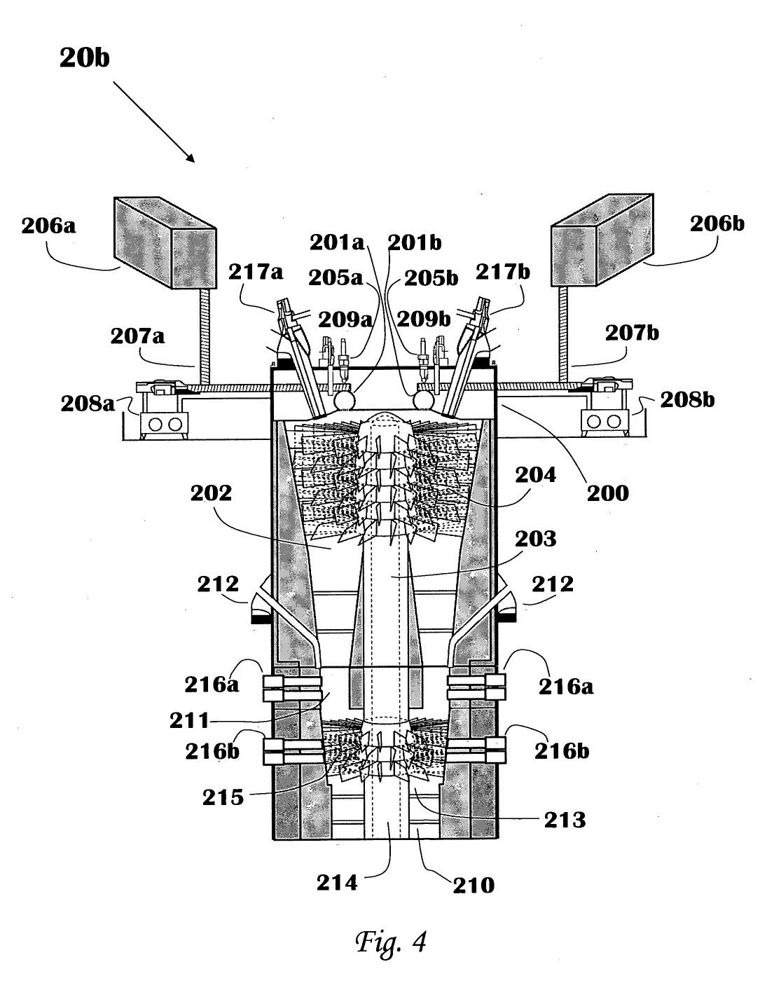

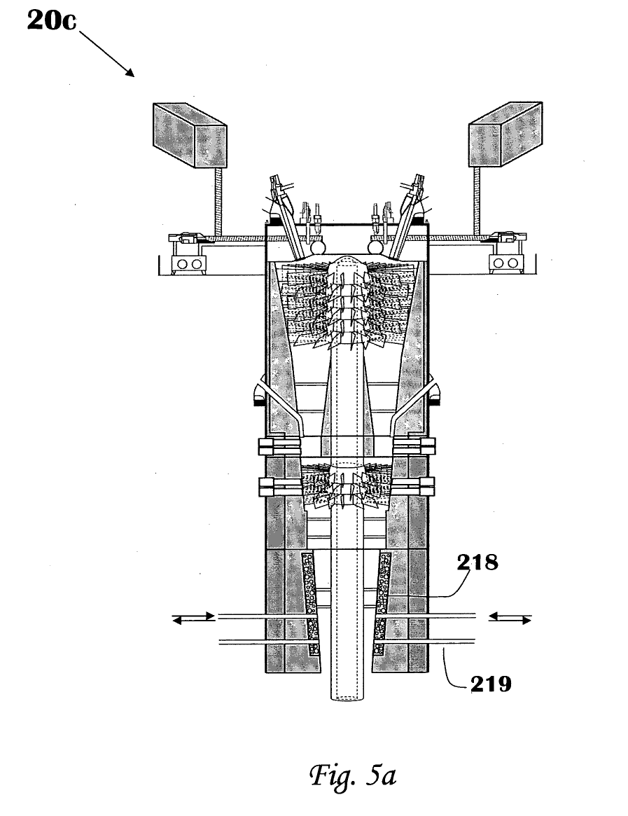

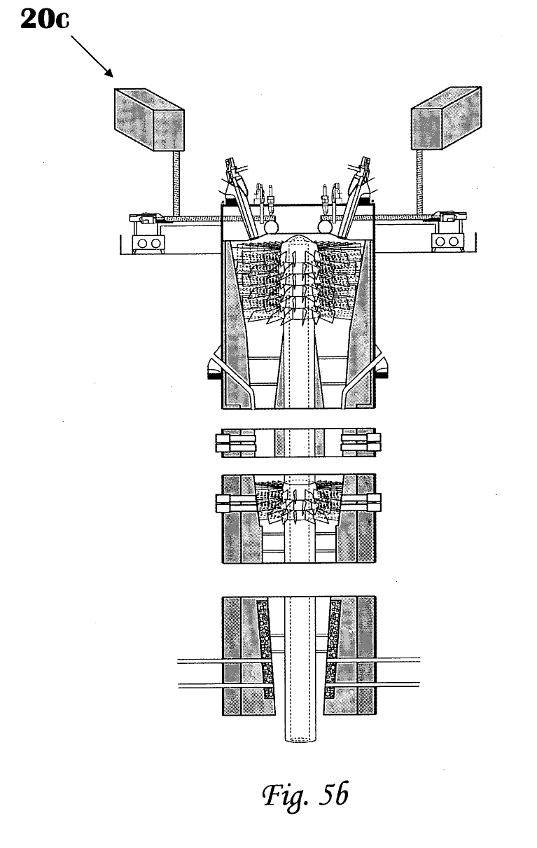

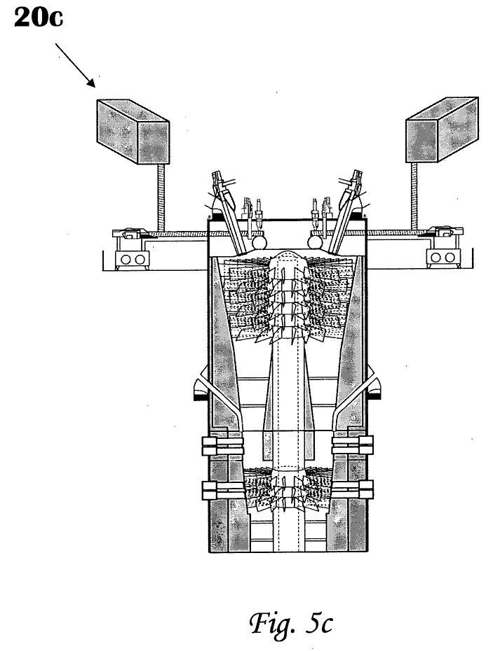

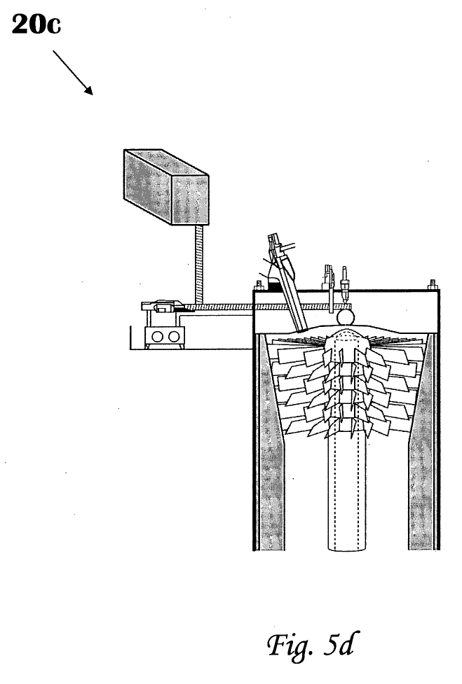

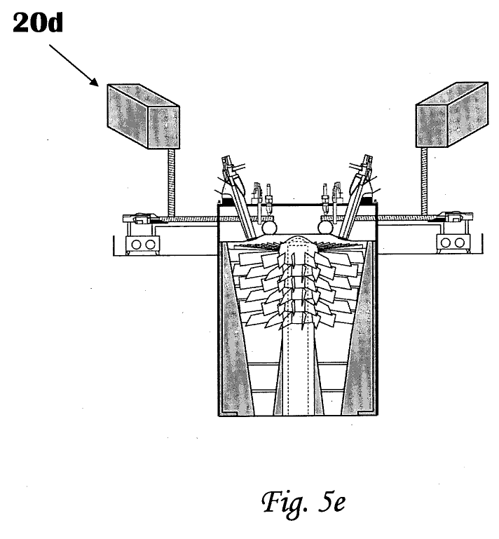

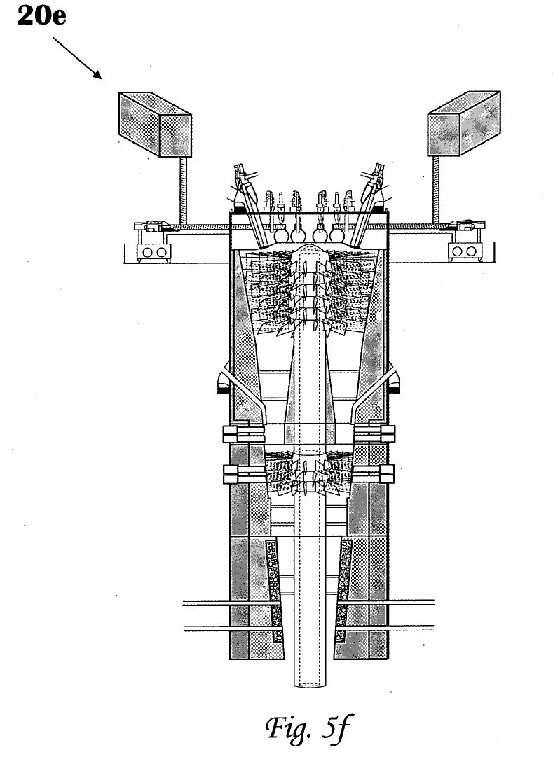

Reference is now made to FIG. 4, in which a schematic diagram of an alternative embodiment 20b of the invention is presented. In this alternative embodiment, combustion of the inflammable components of the gases exhausted from the turbine is used to drive a second turbine. While the specific example illustrated comprises two deflagration chambers, it is understood that this number is for illustrative purposes only, and not to limit the construction of the embodiment to any specific number of deflagration chambers. The gases emitted from the exhaust of the first-stage turbine are admitted into an oxidation chamber 211, in which they are mixed with an appropriate oxidant, which is admitted to the oxidation chamber via an inlet 212. A second-stage turbine, located in a second chamber 213, comprises a shaft 214 and a rotor assembly 215. Combustion of the inflammable component of the gases is initiated in the oxidation chamber (216a); additional means of initiation of combustion may be set up within the rotor assembly chamber (216b) to ensure complete combustion of all the entire inflammable fraction of the gases emitted from the exhaust of the first-stage turbine. Expansion of gases produced by combustion of the inflammable components of the exhaust gas from the initial stage drives the second-stage rotor assembly. The specific embodiment illustrated in FIG. 4 also includes pressure relief valves (217a and 217b) between each of the deflagration chambers and an area outside of the turbine housing. These pressure relief valves are a safety device; each one is set to open if the gas pressure in the deflagration chamber to which it is attached exceeds a predetermined value. The exact limiting pressure will depend on the details of the specific construction, and will be chosen to be a value well below the point at which damage to the structure might occur. Of course, these pressure relief valves may be added to any of the various embodiments of the assembly, and their appearance FIG. 4 is for illustrative and exemplary purposes only, and not intended in any way to limit their use to the specific embodiment illustrated in the figure.

In alternative embodiments of the present invention, the second-stage rotor assembly may be chosen from the group consisting of (a) at least one rotor rotatably supported by the shaft such that each one of the rotors is able to rotate freely and independently; (b) a plurality of rotors rotatably supported by the shaft and configured such that successive rotors rotate in opposite directions; (c) at least one rotor rotatably supported by the shaft and at least one stator supported by the shaft, configured such that rotor(s) and stator(s) are arranged alternately along the shaft. In some alternative embodiments described below, transfer of energy from the turbine is more effectively accomplished if the shaft that supports the rotor assembly rotates relative to the rotor assembly chamber, the shaft then being coupled to an external device, as detailed below. These alternative embodiments comprise at least one rotor assembly non-rotatably supported by the shaft, such that the flow of gas through the turbine causes the rotor assembly and the shaft supporting it to rotate relative to the rotor assembly chamber. In these embodiments of the present invention, the second-stage rotor assembly may be chosen from the group consisting of (a) said shaft constructed sectionally such that at least one section is adapted to rotate about its axis relative to said rotor assembly chamber; at least one rotor rotatably supported by said shaft such that each one of said at least one rotors is able to rotate freely and independently; and at least one rotor non-rotatably supported by said shaft, configured such that each of said at least one non-rotatable rotors is supported by said section of said shaft adapted to rotate relative to said rotor assembly chamber; (b) at least one rotor rotatably supported by said shaft and at least one stator supported by said shaft, configured such that said at least one rotor and said at least one stator are arranged alternately along the shaft; and, (c) said shaft constructed sectionally such that at least one section is adapted to rotate about its axis relative to said rotor assembly chamber; at least one rotor rotatably supported by said shaft; at least one rotor non-rotatably supported by said shaft; and at least one stator supported by said shaft, configured such that said at least one rotor and said at least one stator are arranged alternately along the shaft, and further configured such that each of said at least one non-rotatable rotors is supported by said section of said shaft adapted to rotate relative to said rotor assembly chamber.

In alternative embodiments of the present invention, combustion of the inflammable fraction of the gases exhausted from the first-stage rotor assembly is initiated by means chosen from the group consisting of a flame; an electric spark; a heating plug or apparatus; a plasma plug; or any other means for initiating combustion of inflammable gases.

In an alternative embodiment of the invention, rather than driving a second-stage turbine directly, combustion of the exhaust gases is used to drive a steam turbine. A source of water is provided. Combustion of the inflammable portion of the exhaust gases, described above, is used to heat this water to steam or, alternatively, (at appropriate pressure) to superheated steam. This steam (alternatively superheated steam) is then used to drive a second-stage turbine. In an alternative embodiment, the water system may be run in a closed loop by connecting the steam output of the second-stage steam turbine to a condenser apparatus such that steam escaping the steam turbine is condensed to liquid water in the condenser. This liquid water is then returned to the water source, where it is again heated, and the steam (alternatively superheated steam) that is thus produced is used to drive the steam turbine.

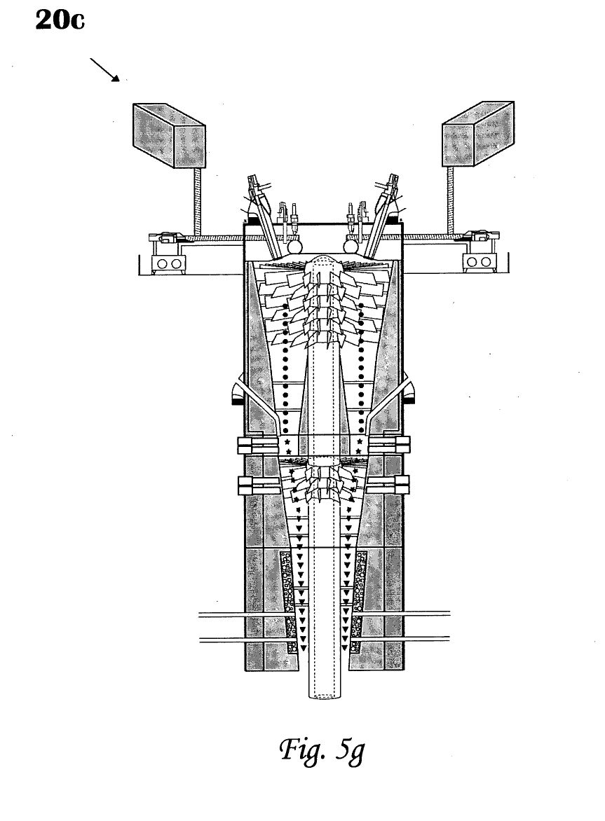

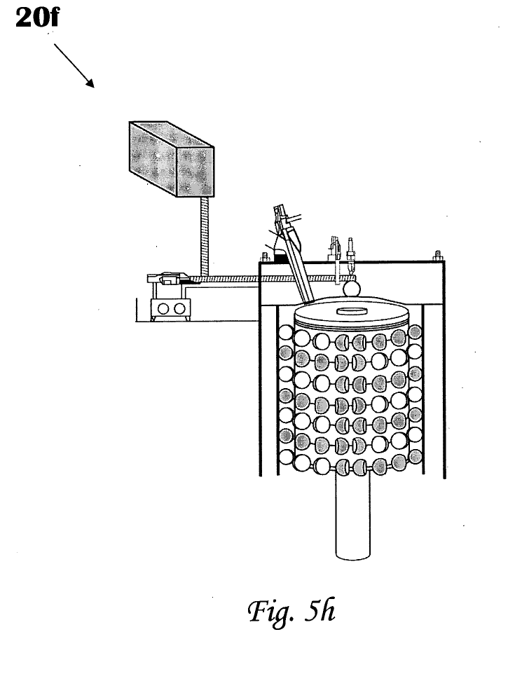

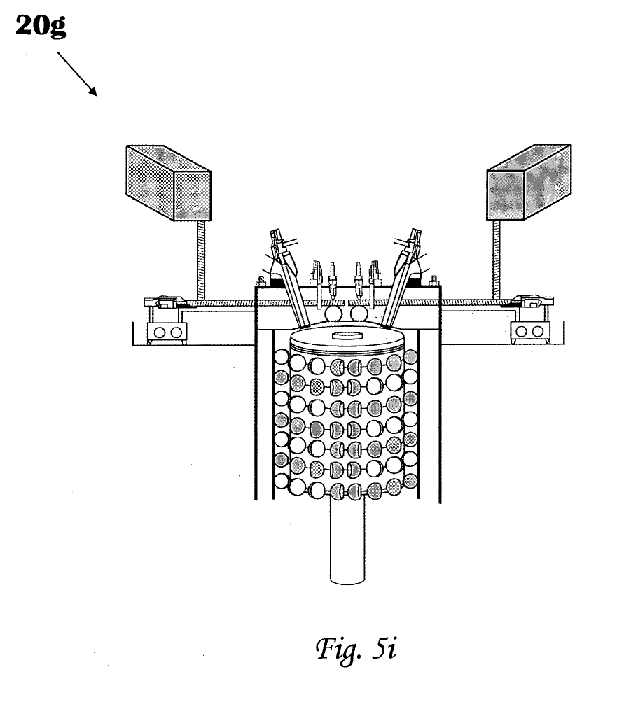

Reference is now made to the group of drawings FIG. 5, in which assembly drawings of a group of additional embodiments 20c-20g is presented (not to scale). FIG. 5a (embodiment 20c) illustrates the inclusion of a heat exchanger apparatus 218. As with the embodiment shown in FIG. 4, a two-stage turbine assembly is shown. It will be obvious to one skilled in the art that there are other alternative embodiments can be constructed that differ in the details of the arrangement of the components of the invention without affecting the essential properties of the invention. It is acknowledged and emphasized that the embodiment shown in FIG. 5 is given for exemplary and illustrative purposes only, and is not to be considered limiting in any sense. In the specific embodiment shown in the figure, the hot gases, after passing through the second-stage turbine assembly, flow past the heat exchanger apparatus. In this specific embodiment, the heat exchanger is in thermal contact with a system of pipes 219 through which a fluid (e.g. air or water) flows to any location external to the turbine assembly desired by the operator. The fluid heated during its passage through the heat exchanger can then be used to heat any desired object, area, or volume. FIGS. 5b and 5c illustrate a modular version of the embodiment in which the first-stage assembly, oxidation chamber, second-stage assembly, and heat exchanger apparatus have been constructed independently and then assembled (such an embodiment can be thus constructed from an existing single-stage turbine assembly via addition of the subsequent modular stages). While in FIGS. 5a-5c, the turbine assembly comprises two independent sources of anaerobic fuel (206a/207a/208a and 206b/207b/208b) and two independent deflagration systems (201a/205a/209a and 201b/205b/209b), FIG. 5d shows an embodiment in which the turbine is driven by a single source of anaerobic fuel and the anaerobic fuel introduced into a single deflagration chamber. FIG. 5e illustrates, as a non-limiting example, another possible design for the first-stage chamber assembly (embodiment 20d), in which the walls of the rotor assembly chamber are modified so as to direct the gases that have passed through the first-stage turbine into the center of the second-stage oxidation chamber. FIG. 5f shows, as a non-limiting example, an alternative embodiment 20e, in which the anaerobic fuel is directed from two independent sources into four independent deflagration chambers. It is acknowledged and emphasized in this respect that the number of storage containers and the number of deflagration chambers are not limited to the numbers shown in the figures, and may be chosen to be any number that is desired by the operator. As an illustrative example, the flow of the gas through embodiment 20c is illustrated in FIG. 5g. The circles indicate the flow of the products of deflagration of the fuel through the first stage. As the gases exit the first stage, and enter the oxidation chamber, they are mixed with an appropriate oxidant; this mixture is indicated by stars. The flow of the mixture after combustion (said mixture comprising the non-flammable portion of the output of the first stage and the products of combustion of the inflammable portion) is indicated by triangles. Finally, FIGS. 5h and 5i indicate, by way of non-limiting example, alternative embodiments in which in which the “blades” of the rotor assembly are actually buckets; FIG. 5h shows an embodiment 20f constructed with one fuel storage container and one deflagration chamber, while FIG. 5i shows an embodiment 20g constructed with two fuel storage containers and two deflagration chambers.

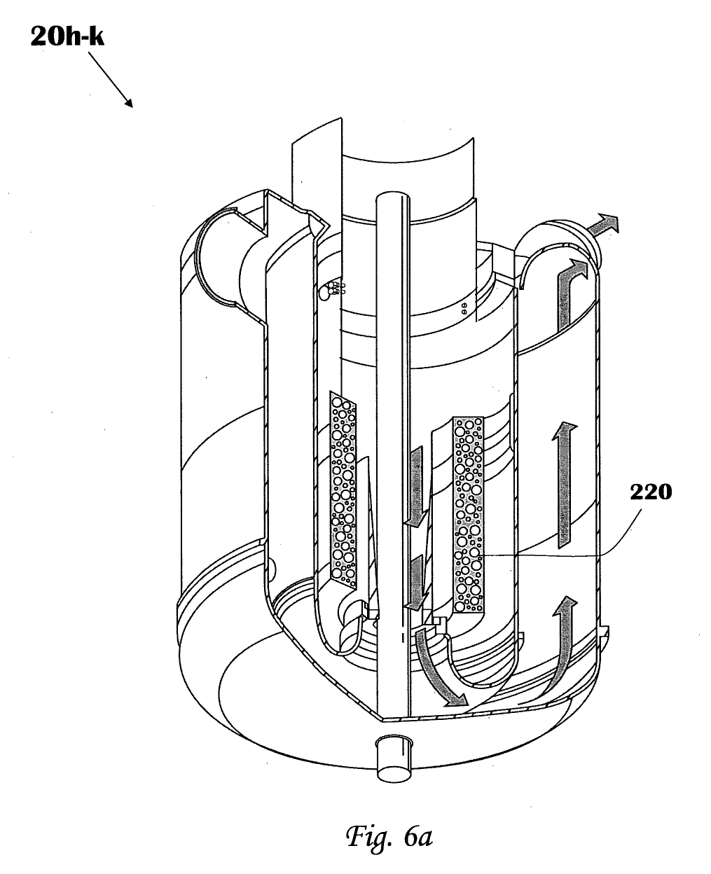

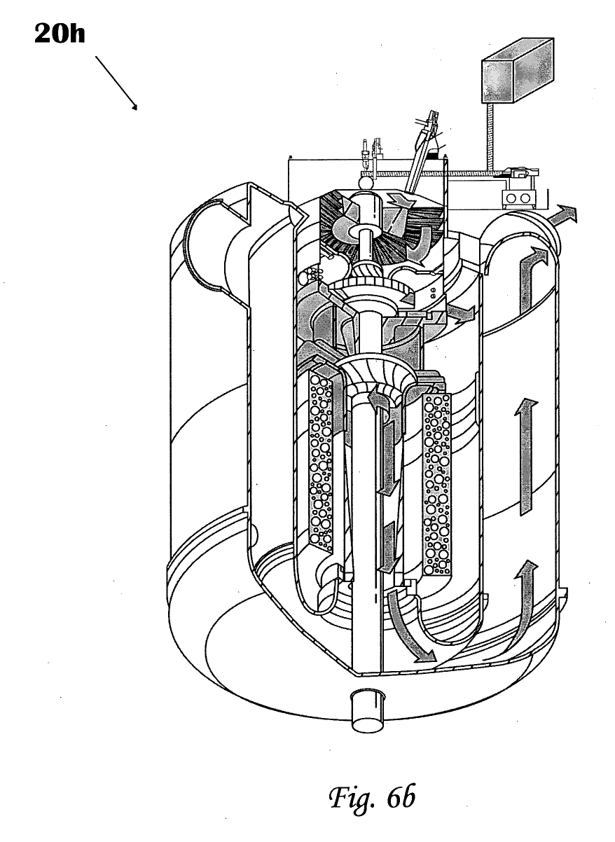

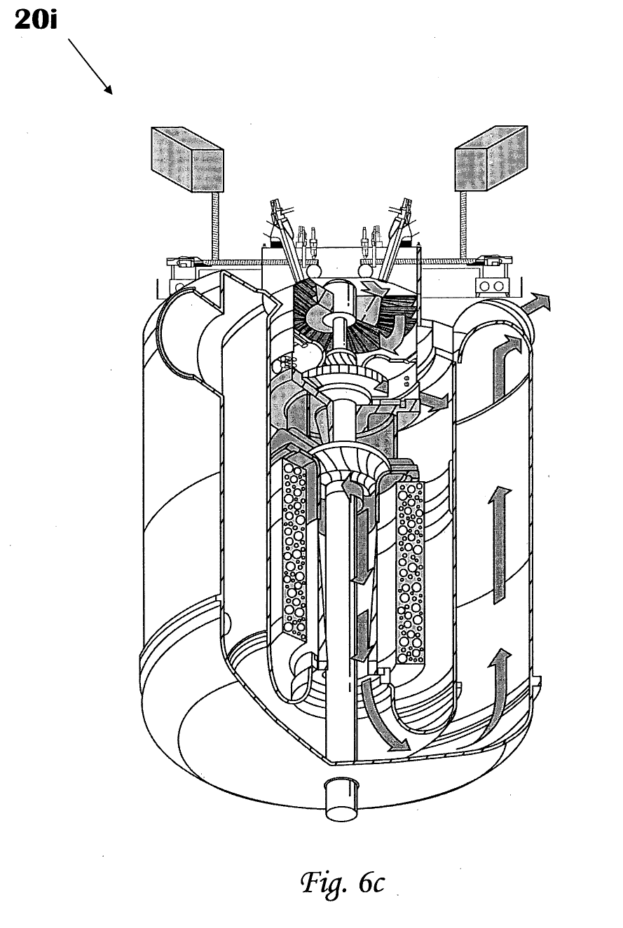

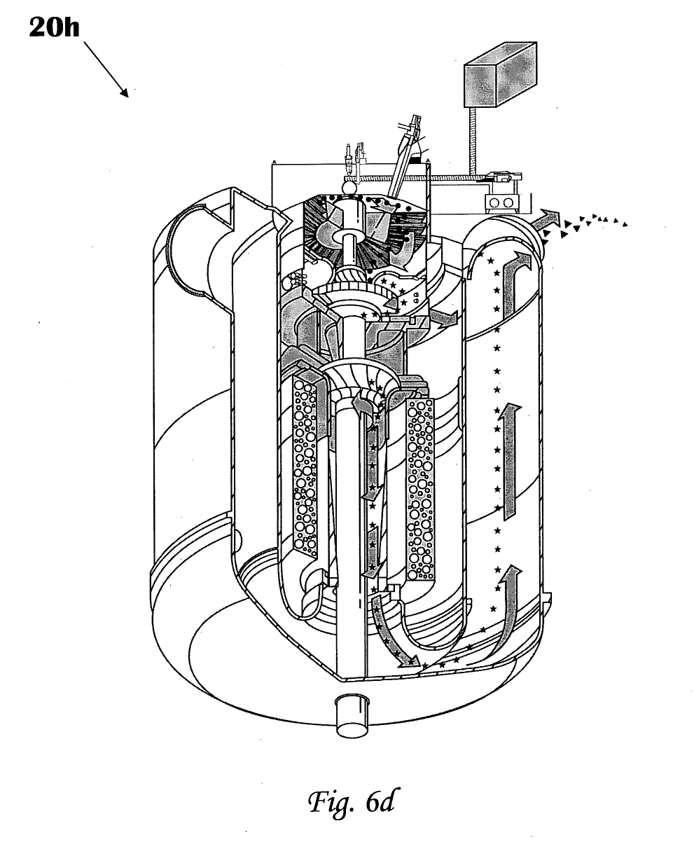

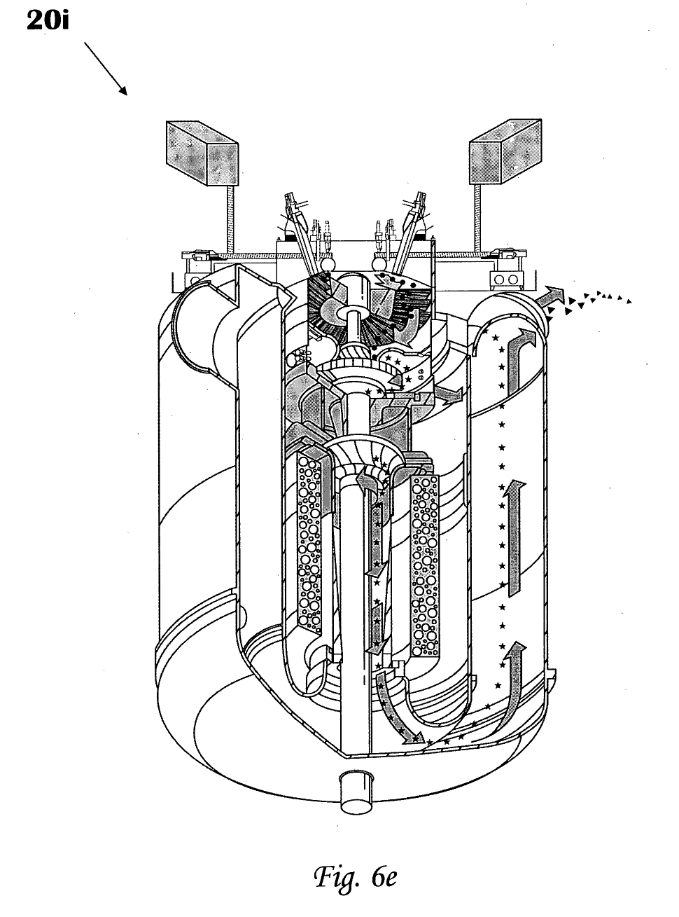

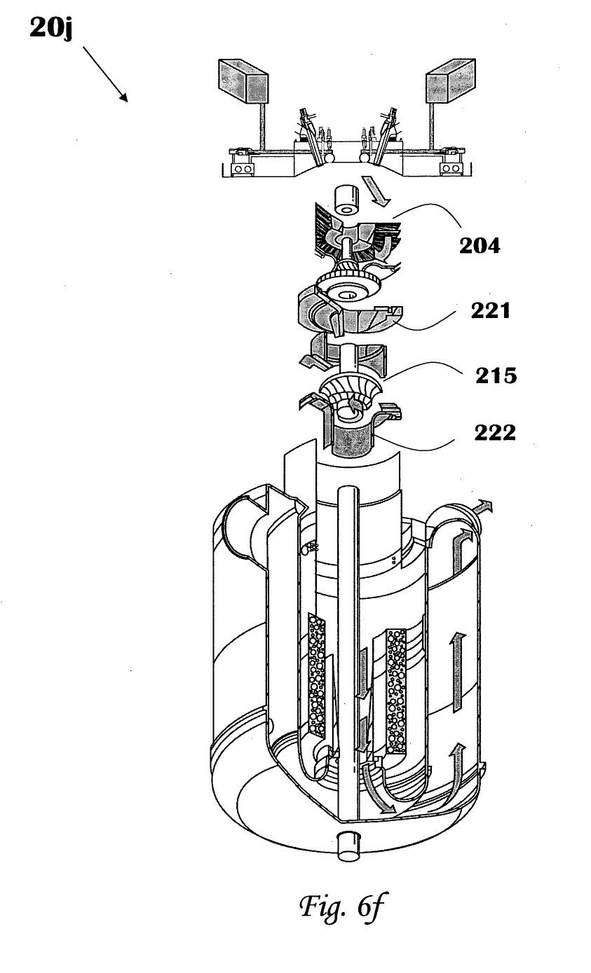

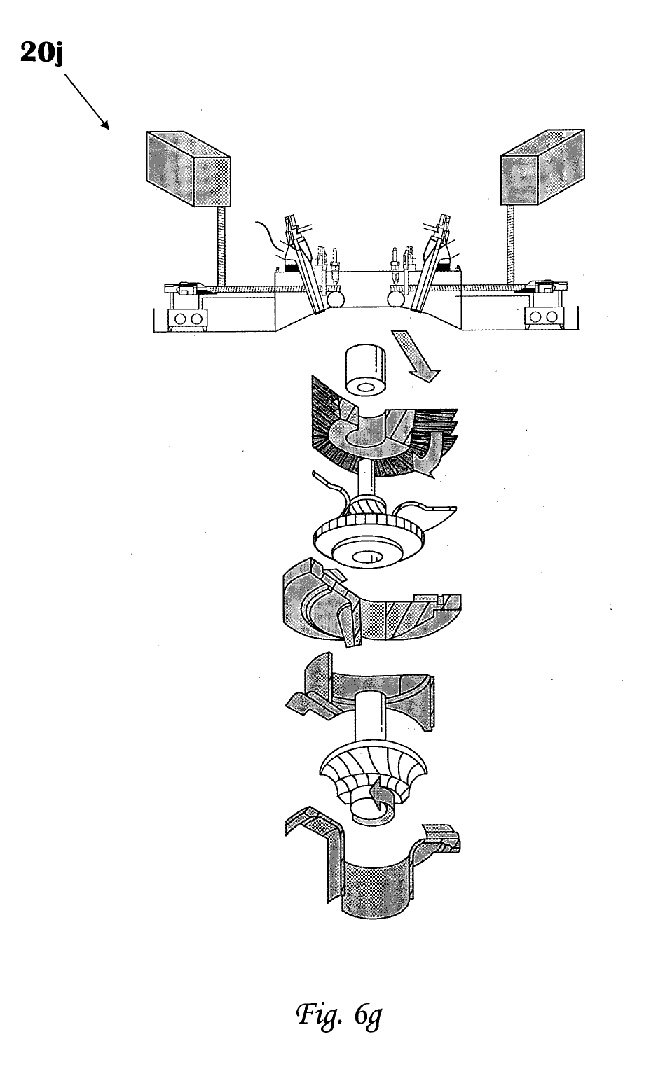

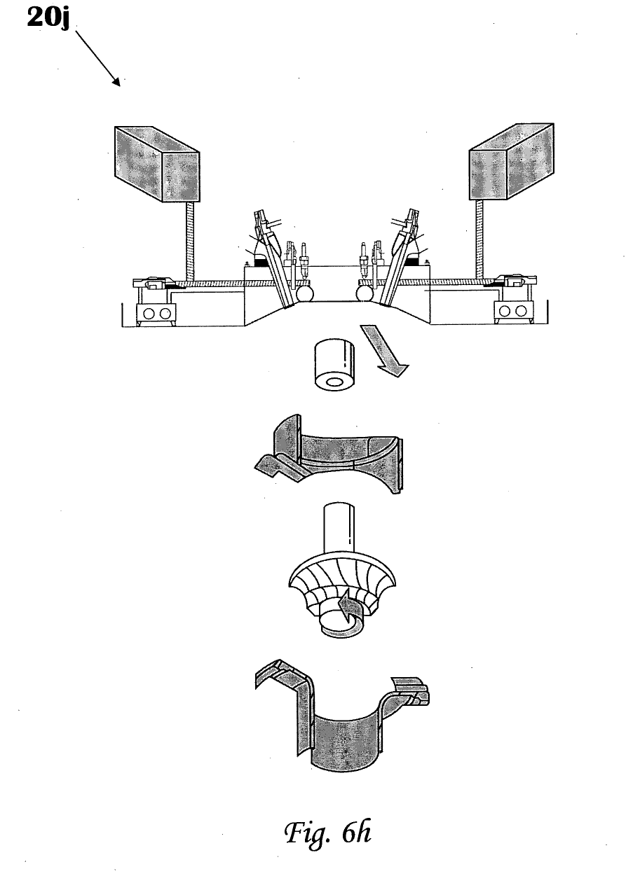

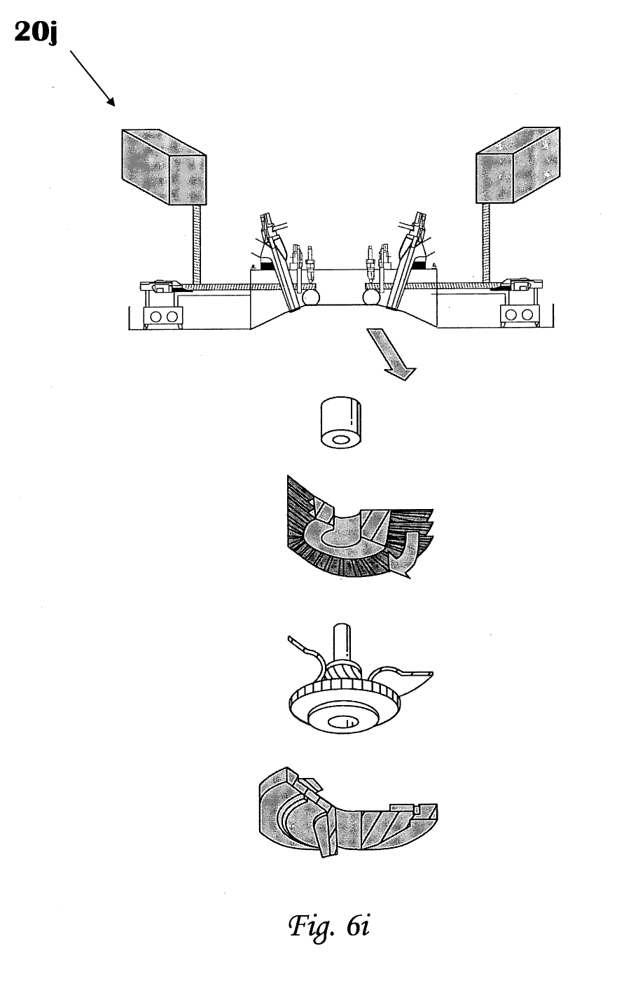

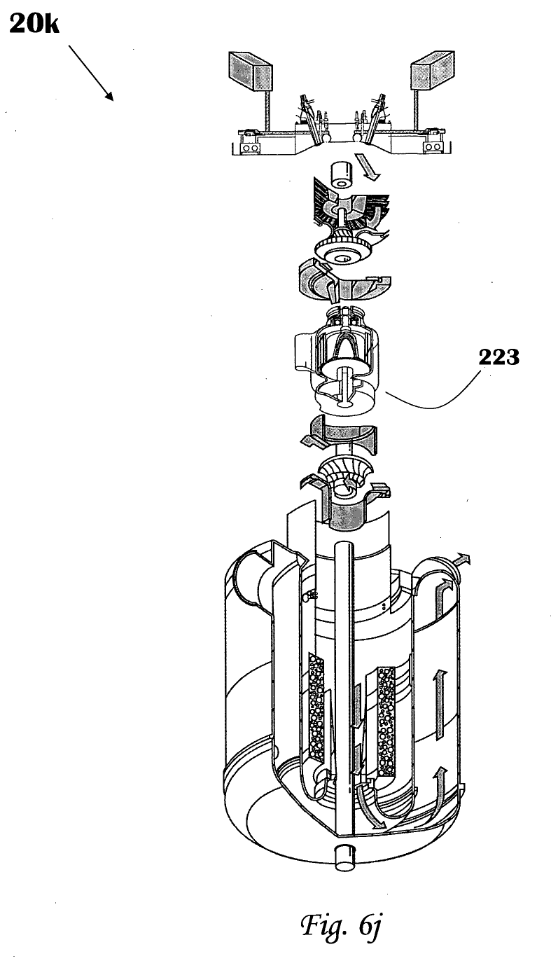

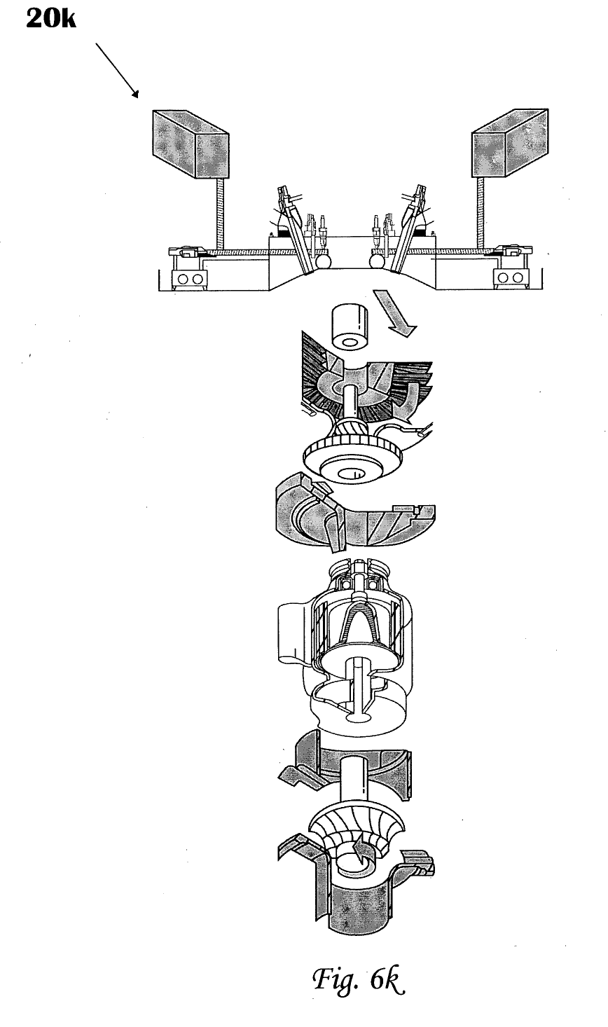

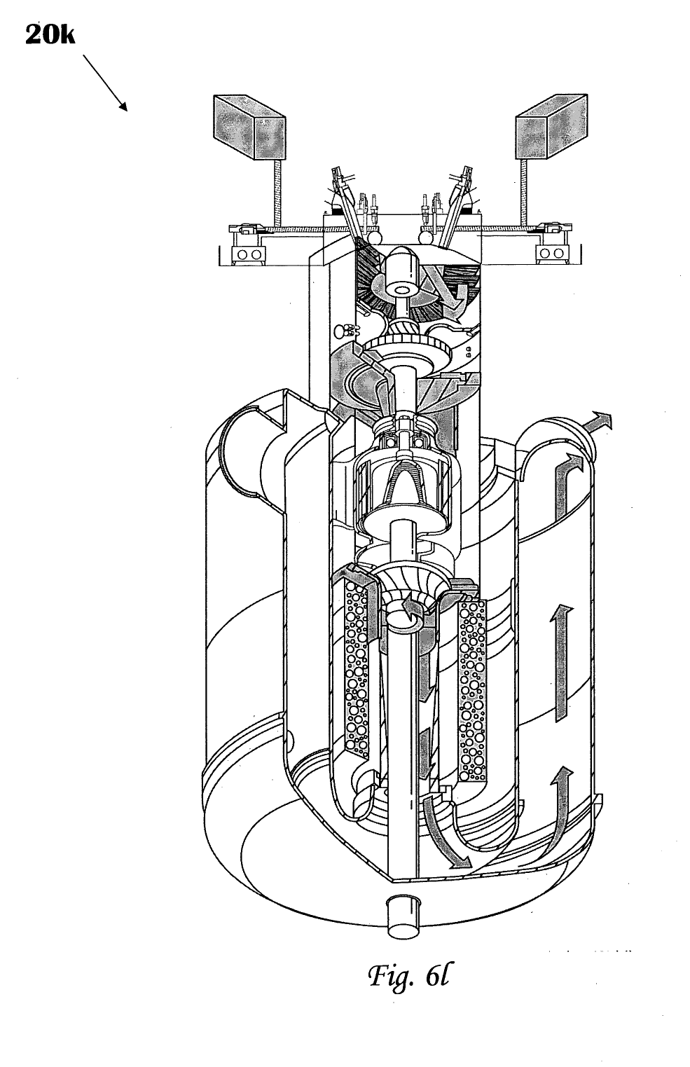

Reference is now made to the group FIG. 6, in which a group of alternative embodiments 20h-20k are presented schematically (not to scale). Again, it is acknowledged and emphasized that the figure is presented for illustrative and exemplary purposes only, and is not intended to be limiting in any sense. It will be obvious to one skilled in the art that alternative embodiments that differ in the details of construction can be designed without affecting the essential properties of the invention. In the embodiment illustrated in FIG. 6, rather than passing over a heat exchanger or being vented to atmosphere, the exhaust gases from the turbine assembly (in this particular case, from the second-stage turbine assembly) are diverted into a closed channel 220. The exhaust gases flow through this closed channel to any external location desired by the operator. As an illustrative and non-limiting example, the hot gases can flow through the closed channel to a heat exchanger external to the turbine assembly, and the heat thus used to heat a desired area or volume. FIG. 6a illustrates for clarity this portion of the assembly without the turbine itself, with the gas flow indicated by arrows. FIGS. 6b and 6c present assembly drawings (not to scale) of alternative embodiments 20h and 20i, respectively, (again, shown for illustrative purposes and not in any way limiting), in which the embodiment comprises one and two sets of storage apparatus/supply apparatus/deflagration chamber, respectively. The flow of the gases through the embodiments is detailed in FIGS. 6d and 6e. The hot gases emanating from the turbine assembly are shown as stars, and the cooled gases (after passage over the heat exchanger) as triangles. Exploded drawings (not to scale) of an embodiment 20j are shown in FIGS. 6f-6i. FIG. 6f shows (for illustrative purposes, and not in any sense as a limiting example) the construction of the embodiment, in which a nozzle 221 directs the flow of gas from the first stage (gases produced in deflagration and which have passed through the first-stage turbine assembly 204) into the second stage, and a second nozzle 222 directs the flow of gas from the second stage (following combustion and passage through the second stage turbine assembly 215) to the heat exchanger. FIGS. 6g-6i present views of the embodiment presented in greater detail.

In some cases, under the turbine assembly's working conditions, the deflagration of the fuel can actually produce a significant amount of ionization of the expelled gas. FIGS. 6j-6l illustrate an embodiment 20k in which use made be made of this property: the shaft 203 is surrounded by a generator 223, which creates an electrical current induced by the flow of charged particles from the first stage into the second stage. Exploded views (not to scale) are shown in FIGS. 6j and 6k, while an assembly drawing (also not to scale) is shown in FIG. 61.

FIGS. 6f-6l illustrate embodiments with two fuel storage units and two deflagration chambers. As above, it is acknowledged and emphasized that this number is chosen for illustrative and exemplary purposes only, and that the actual number of storage units and deflagration chambers is chosen by the operator and will depend on the detailed needs of the particular application.

Additional embodiments relate to different forms of the anaerobic fuel. In one alternative embodiment of the invention disclosed herein, the anaerobic fuel is a chemical fuel and/or anaerobic propellant.

In alternative embodiments of the invention disclosed herein, the chemical fuel is selected from the group consisting of RDX (C₃H₆N₆O₆), TNT (CH₃C₆H₂(NO₂)₃), HMX, cellulose, nitrocellulose, nitroglycerin and any combination thereof.

In alternative embodiments of the invention disclosed herein, the anaerobic propellant is selected from the group consisting of compositions of sulfur, ammonium nitrate, ammonium picrate, aluminum powder, potassium chlorate, potassium nitrate (saltpeter), nitrocellulose, pentaerythiotol tetranitrate (PETN), CGDN, 2,4,6 trinitrophenyl methylamine (tetryl) and other booster explosives, a mixture of about 97.5% RDX, about 1.5% calcium stearate, about 0.5% polyisobutylene, and about 0.5% graphite (CH-6), a mixture of about 98.5% RDX and about 1.5% stearic acid (A-5), cyclotetramethylene tetranitramine (HMX), octogen-octahydro-1,3,5,7 tetranitro 1.3.5.7. tetrazocine, cyclic nitramine 2,4,6,8,10,12-hexanitro-2,4,6,8,10,12-hexaazaisowurtzitane (CL-20), 2,4,6,8,10,12-hexanitrohexaazaisowurtzitan (HNIW), 5-cyanotetrazolpentaamine cobalt III perchlorate (CP), cyclotrimethylene trinitramine (RDX), triazidotrinitrobenzene (TATNB), tetracence, smokeless powder, black powder, boracitol, triamino trinitrobenzene (TATB), TATB/DATB mixtures, triethylene glycol dinitrate (TEGDN), tertyl, trimethyleneolethane trinitrate (TMETM), trinitroazetidine (TNAZ), sodium azide, nitrogen gas, potassium oxide, sodium oxide, silicon dioxide, alkaline silicate, salt, saltwater, water from any manmade or natural body of water, diphenylamine, dyestuffs, cellulose, wood, fusel oil, acetobacteria, algae, or any combination thereof.

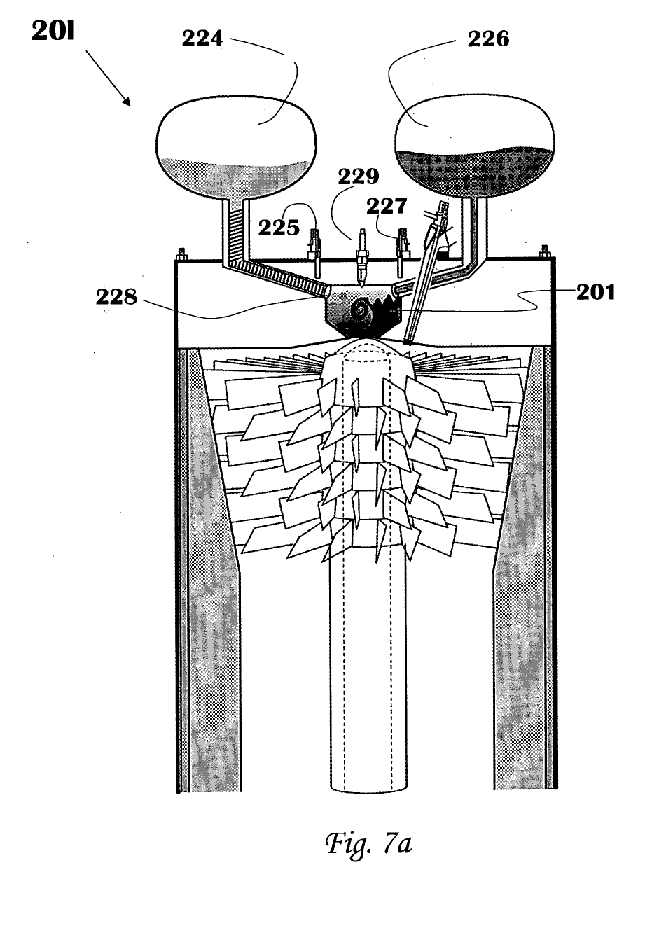

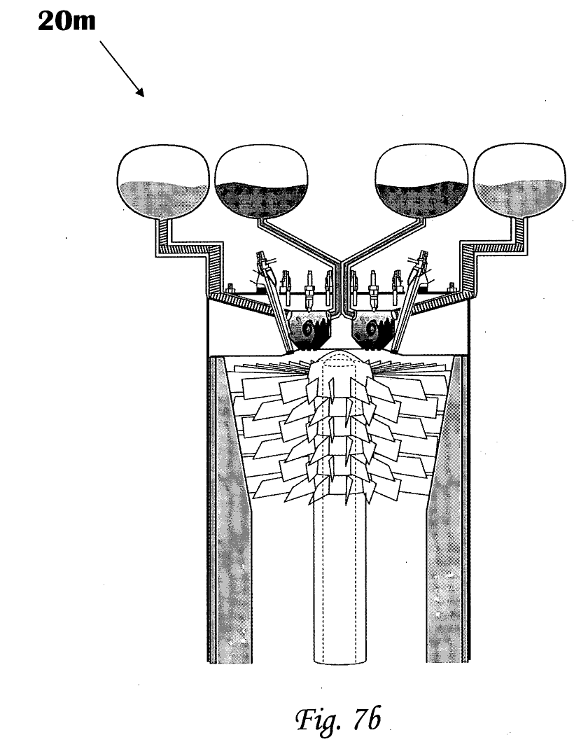

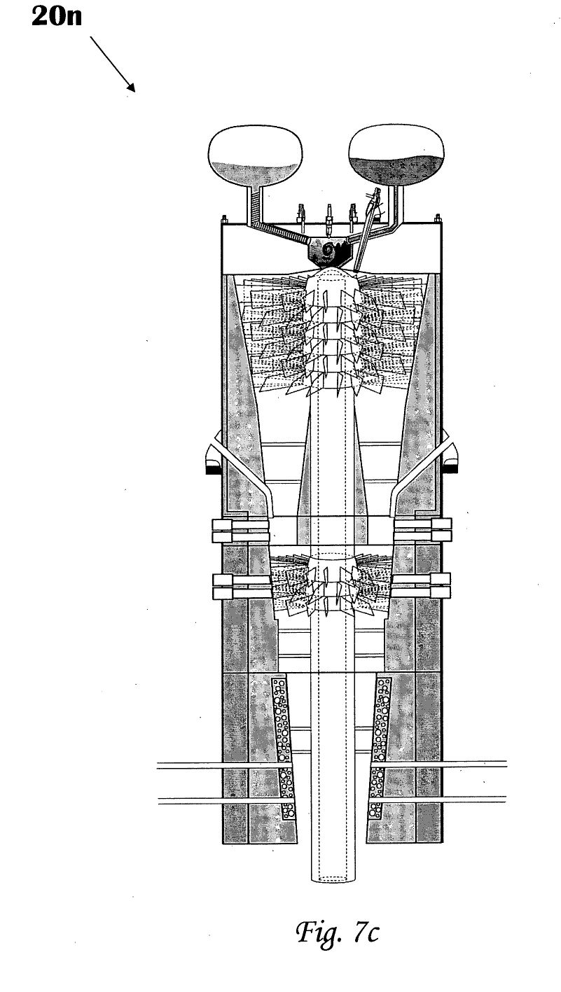

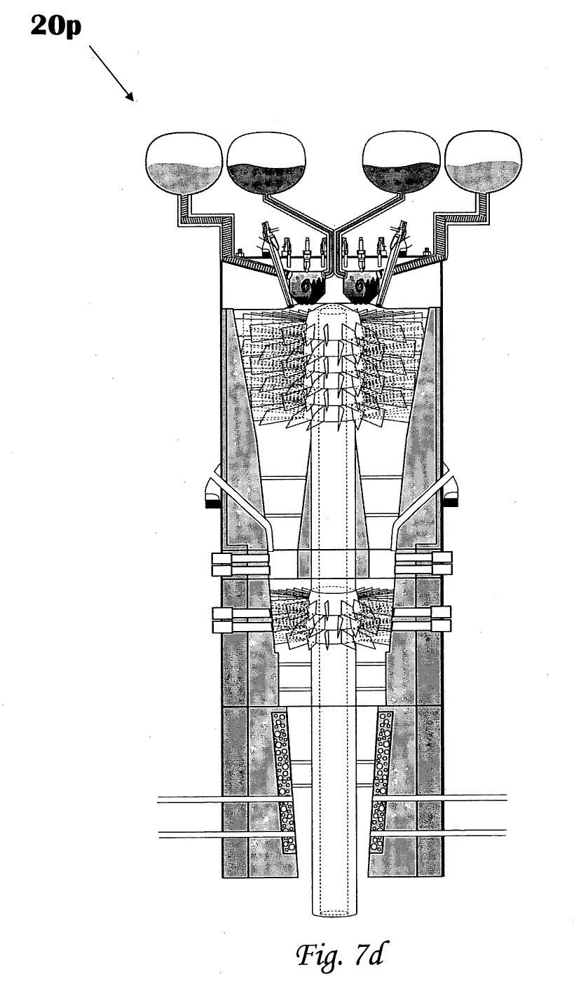

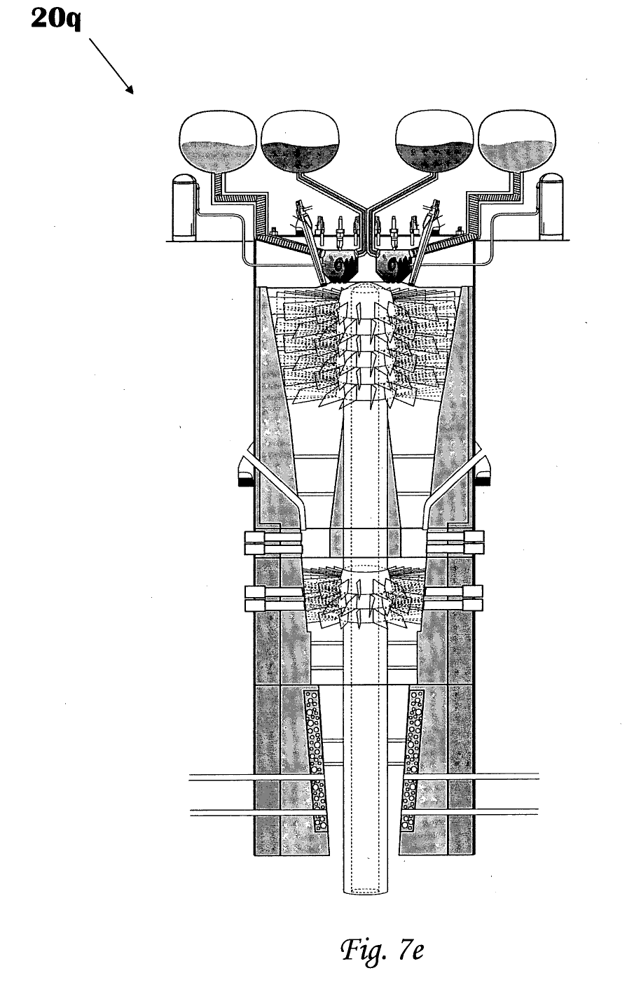

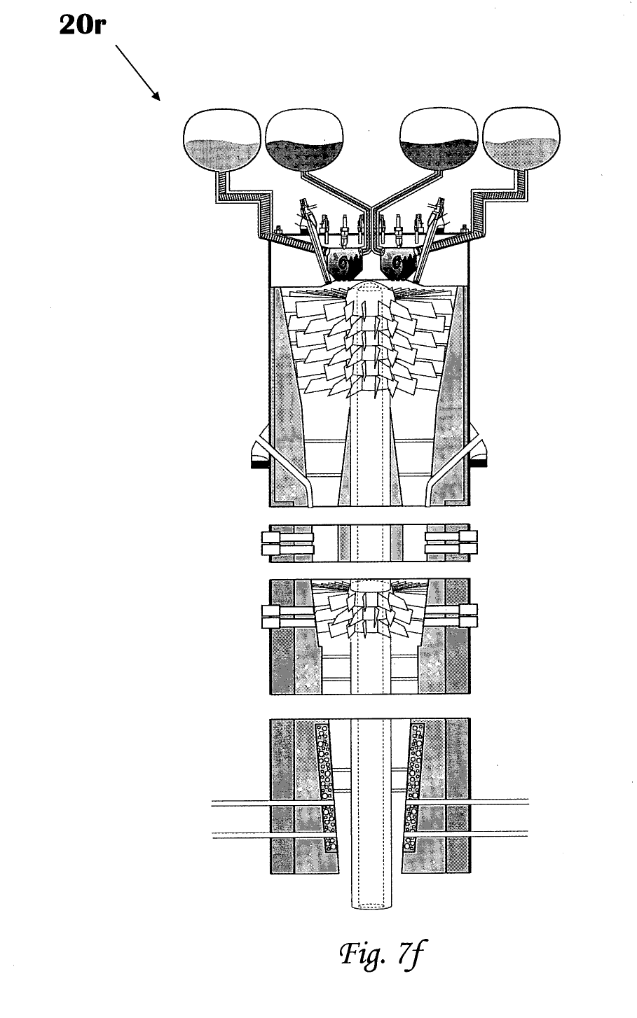

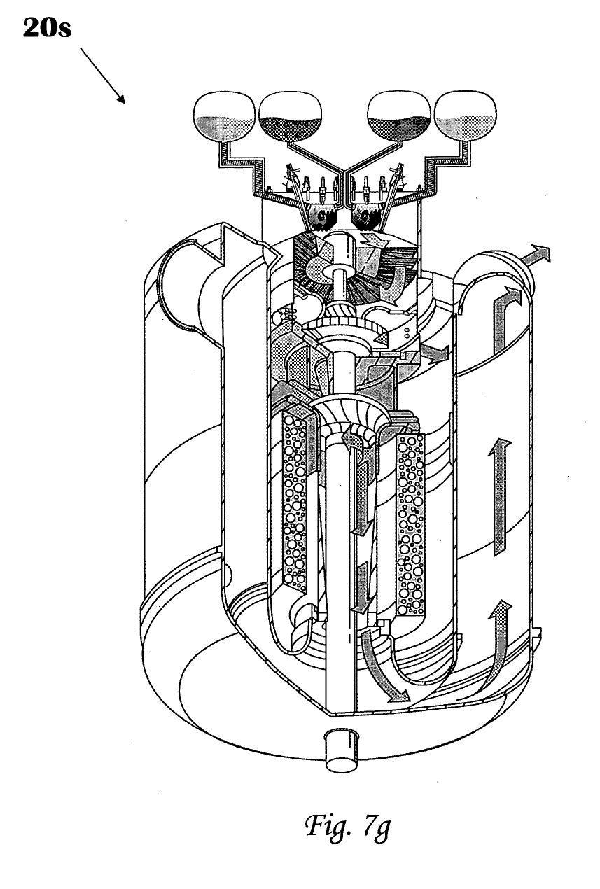

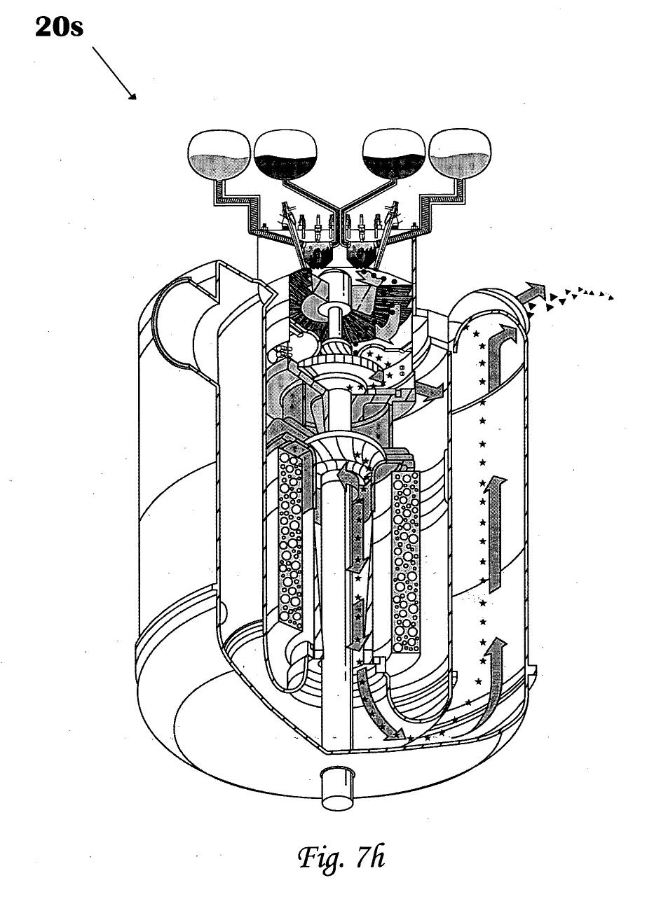

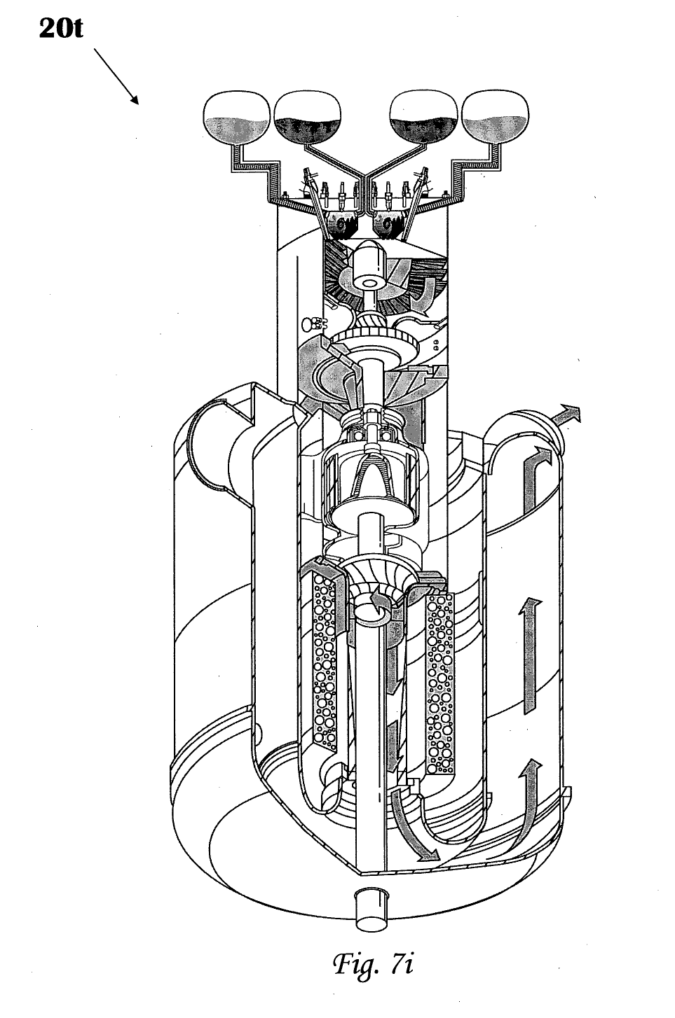

Reference is now made to the group of FIG. 7, illustrating an additional embodiment in which the fuel is nitrocellulose produced in situ from a nitrating agent and cellulose. A typical embodiment 201 is shown in FIG. 7a. The nitrating agent (typically highly concentrated nitric acid) is stored in a nitrating agent container (NAC) 224. In particular, the container is constructed out of material resistant to attack by highly concentrated HNO₃, e.g., type 316L stainless steel. It is also designed to be leak-proof so that the nitrating agent cannot escape and possibly damage other components of the invention. It is acknowledged and emphasized that the operation of the apparatus is independent of the size of the container for the nitrating agent. The actual volume of the container will depend on the specific needs of the operator according to considerations such as, e.g., the amount of available space, the rate at which the nitrating agent is used, and so on. An example of an NAC that meets the criteria for use in the present invention is the commercially available W.J. Acidic ISO Container™. The nitrating agent exits the container via a dedicated outlet. This outlet is also sealable such that when it is closed, the nitrating agent cannot escape from the container. In the preferred embodiment shown in FIG. 7, the container for the nitrating agent is sealed by a valve 225, which, like the rest of the container, is manufactured from materials (e.g. type 316L stainless steel body and Viton® seals) resistant to attack by the nitrating agent. The valve may be chosen from, in a non-limiting manner, a mechanical valve, an electric valve, a pneumatic valve, and electropneumatic valve, or any other kind of valve that (a) can effect the required seal (sufficient to prevent leakage of the nitrating agent or its vapors from the container) when closed, (b) while open will permit the nitrating agent to flow out of the container at any rate predetermined by the user, and (c) the surfaces wetted by the nitrating agent are made of materials resistant to it (e.g. ceramic, glass, etc.). In the embodiment shown in FIG. 7a, valve 225 is adapted for remote actuation by an external controller. In this embodiment, the flow of nitrating agent from the storage chamber is effected by a pump (which can be of any type suitable for transport of the nitrating agent); the predetermined rate at which nitrating agent flows from the NAC to its desired final location outside of the container (normally the deflagration chamber) is controlled by (a) the speed of the pump; (b) the conductance of valve 225; and (c) the conductance of the pipe, tube, or other channel through which it flows. Normally, the apparatus will be constructed such that the flow of the nitrating agent from its container is limited only by the speed of the pump, but the construction of the apparatus is not limited to this case alone. It is acknowledged and emphasized that the actual rate of flow of the nitrating agent will depend on the specific needs of the user, and will be set by the user at the point of use in order to optimize the specific operation conditions of operation in practice.

In the embodiment shown in FIG. 7a, cellulose is stored in a cellulose container (CC) 226. This container is independent of the NAC described above. It is acknowledged and emphasized that the operation of the apparatus is independent of the size of the CC. The actual volume of the CC will depend on the specific needs of the operator according to considerations such as, e.g., the amount of available space, the rate at which the cellulose is used, and so on. The CC is leak-proof; in this case, the primary concern is degradation of the cellulose within the container due to reaction with oxygen or water vapor in any air that leaks in, or with the nitrating agent in the event of a catastrophic failure of the storage container for the nitrating agent. Both the inlet and the outlet to the CC are sealable such that when both are closed, the cellulose storage container is airtight. In the embodiment depicted in FIG. 7a, the outlet seal is effected by a valve 227. The valve may be chosen from, in a non-limiting manner, a mechanical valve, an electric valve, a pneumatic valve, and electropneumatic valve, or any other kind of valve that can effect the required seal (sufficient to prevent leakage of the nitrating agent or its vapors from the container) when closed, and while open will permit the nitrating agent to flow out of the container at any rate desired by the user. In the embodiment shown in FIG. 7a, valve 227 is adapted for remote actuation by an external controller. An example of a container that meets all of the criteria listed is the commercially available W. J. Cellulose Storage Container™. In the embodiment shown in FIG. 7a, the flow of cellulose from the CC is effected by a pump (which can be of any type suitable for transport of the nitrating agent; the rate at which cellulose flows from the container to its desired final location outside of the CC is controlled by (a) the speed of the pump; (b) the conductance of valve 227; and (c) the conductance of the pipe, tube, or other channel through which it flows. Normally, the apparatus will be constructed such that the flow of cellulose from its container is limited only by the speed of the pump, but the construction of the apparatus is not limited to this case alone. It is acknowledged and emphasized that the actual rate of flow of the cellulose will depend on the specific needs of the user, and will be set by the user at the point of use in order to optimize the specific operation conditions of operation in practice.

Deflagration chamber 201 is interconnected to the two storage chambers such that material can flow independently from each of the chambers into the reaction chamber and that no mixing of cellulose and the nitrating agent can occur outside of the reaction chamber. In order to disperse the nitrating agent within the reaction chamber, the inlet is connected to a nozzle 228 such that the nitrating agent passes from the inlet into the nozzle and exits the nozzle in the form of a fine spray or mist. At least one heating plug and/or spark plug 229 passes through an external wall of the reaction chamber. In the embodiment shown in FIG. 7a, the apparatus comprises a single heating plug and/or spark plug; additional embodiments may contain any number of heating plugs and/or spark plugs desired by the user. A seal is made between the exterior of the heating plug and/or spark plug and reaction chamber such that gases cannot escape from around the sides of the heating plug and/or spark plug. As a non-limiting example, the heating plug and/or spark plug can be welded directly to the exterior wall of reaction chamber 201 in cases where the materials of construction are appropriate for welding; or it can be mounted on a flange that is attached in a leak-proof fashion to the reaction chamber; or it can be screwed into a threaded hole adapted for insertion of a heating plug and/or spark plug; or it can be attached in any other way that is convenient for the particular application for which the apparatus is intended. The heating plug and/or spark plug is a commercially available tungsten plug, heated by resistive heating in a predetermined manner. In the embodiment illustrated in FIG. 7a, sufficient voltage is applied to the plug to bring it to a temperature of about 230° C. to about 300° C. It is acknowledged and emphasized that the operation of the apparatus in this temperature range is not limited to the preferred embodiment or to any specific additional embodiment, and that the actual temperature at which the apparatus will be operated (and hence the detailed construction of the heating plug(s) and/or spark plug(s)) will be chosen by the user in order to optimize the performance of the apparatus under the specific conditions under which it is being used.

Alternative embodiments incorporating dual-component fuel are illustrated schematically (not to scale) in FIGS. 7b-7i. FIG. 7b illustrates embodiment 20m in which the fuel is prepared and deflagrated in two independent deflagration chambers 201a and 201b (cf. FIG. 4). In this embodiment, the fuel components are stored in two sets of NACs and CCs, each of which feeds a single deflagration chamber. In embodiment 20m, each deflagration chamber has a separate means of heating, so that formation and deflagration of the fuel in each deflagration chamber is independent of that in the other. The operator may thus control the relative timing of deflagrations in the two chambers as desired for maximum efficiency. It is in the scope of the present invention that the number of deflagration chambers in embodiments in which dual-component fuel is used may be any number desired by the operator, consistent with the needs of the particular use to which the turbine is being put, available space, etc. It is acknowledged and emphasized in this respect that FIGS. 7a and 7b are presented for illustrative and exemplary purposes only, and are not intended in any sense to limit the details of design and/or construction of the invention disclosed herein to those illustrated in the figures. FIGS. 7c-7f illustrate additional embodiments 20n through 20r in which dual-component fuel is used to drive a dual-stage turbine analogous to the embodiments illustrated in FIGS. 4 and 5. In the specific embodiments illustrated in FIGS. 7c-7f, the dual-stage turbine additionally comprises a second stage driven by combustion of the inflammable portion of the gases produced in the deflagration of the dual-component fuel and a heat-exchange apparatus for using the heat generated by the second-stage combustion. In FIG. 7c, an embodiment 20n is illustrated in which one NAC and one CC provide the components of the dual-component fuel to a single deflagration chamber. FIGS. 7d-7f illustrate embodiments in which two independent sets of NAC+CC provide the components of the dual-component fuel to two independent deflagration chambers. It is within the scope of the present invention to include embodiments that comprise any number of deflagration chambers desired by the operator, and it is acknowledged and emphasized that the particular designs shown in the figures are given for illustrative and exemplary purposes only and are not intended in any sense to limit the design and/or construction to the specific number of NACs, CCs, or deflagration chambers shown in the illustrations. FIG. 7d illustrates embodiment 20p, which is identical to 20n except for the addition of a second set of NACs and CCs and a second deflagration chamber. In embodiment 20q, illustrated in FIG. 7e, an additional set of containers is provided. These containers provide any additional materials that the operator wishes to provide to the deflagration chamber, e.g., dyestuffs, inhibitors, etc. FIG. 7f illustrates embodiment 20r, in which the dual-component fuel drives a fully modular dual-stage turbine, illustrated schematically in an exploded view.

FIGS. 7g-7i illustrate yet another additional family of embodiments. In these embodiments, the dual-component fuel drives a turbine in which the hot gases produced by deflagration of the fuel are used first to drive the turbine and then as a source of heat for an additional application (e.g. heating a building). Embodiment 20s (FIGS. 7g and 7h) shows a construction comprising two sets of fuel precursor containers and two reaction chambers. The flow of gases through the apparatus is illustrated in FIG. 7h. Gases produced by deflagration of the dual-component fuel exit the reaction chambers and pass through the turbine chamber, driving the turbine (circles). The gases then flow through the apparatus and past a heat exchanger (stars), after which they are exhausted from the turbine apparatus (triangles). FIG. 7i illustrates embodiment 20t, in which the reaction chamber is designed such that the deflagration produces a sufficiently high temperature and pressure to measurably ionize the gases discharged from the reaction chamber. The flow of charged particles through the apparatus is used to drive a generator, the magnet of which surrounds the channel through which the gases flow. It is within the scope of the invention to include any number of reaction chambers, any number of fuel precursor containers, any physical size for the apparatus, any turbine design, and any other details of the construction and control of the apparatus. It is acknowledged and emphasized that the group of FIG. 7 is presented for illustrative and exemplary purposes only, and not to limit the present invention to the specific designs illustrated in the figures. The details of the construction of the adaptation of the present invention for use to drive a turbine will depend on the specific needs of the user, and the invention can be used for any power or energy output desired by the user.

In additional embodiments, the anaerobic fuel is adapted to provide multiple independent deflagrations from each quantity of fuel conveyed to the deflagration chamber. As a non-limiting example, such independent deflagrations can be achieved by producing the anaerobic fuel in the form of pellets, each pellet comprising a plurality of layers of fuel. The deflagration of each layer will start only after the completion of deflagration of the previous layer. The exact sequence, timing, and energy of each successive deflagration can be controlled by varying the thickness and content of the layers in the fuel pellets. Alternatively, such independent deflagrations can be accomplished by providing the anaerobic fuel in capsule form, with each capsule comprising a plurality of smaller capsules, each of which contains a predetermined quantity of anaerobic fuel. Again, the exact sequence, timing, and energy of each successive deflagration can be controlled by varying the volume and content of each of the smaller capsules within the larger capsule. In other alternative embodiments, the anaerobic fuel is provided in a form chosen from the group of solid, gel, flakes, liquid, powders of any size and/or shape, or any combination thereof, in which each of the individual members of the combination contains a predetermined quantity of the anaerobic fuel.

Alternative embodiments relate to the means by which the fuel is ignited. Means for igniting the anaerobic fuel can be chosen, in a non-limiting manner, from the group consisting of (a) an electric spark; (b) a heating plug or apparatus; (c) a plasma plug; (d) any other method to ignite said anaerobic fuel.

In another alternative embodiment of the invention, the invention additionally comprises means for conveying, igniting, and deflagrating a quantity of anaerobic fuel according to a predetermined sequence. In one specific alternative embodiment, the conveyance, ignition, and deflagration of a quantity of anaerobic fuel is accomplished while deflagration of a second quantity of anaerobic fuel is taking place. In this particular embodiment, the initiation of deflagration of new material while deflagration of a prior quantity is still underway has the net effect of making the gas pressure at the turbine head more constant with time, rather than spiking as each new quantity of fuel is ignited.

It must be emphasized that this invention is not restricted to turbines of any particular size, scale, or energy output. The current invention includes any application for which a turbine can be useful, e.g., the commercially available W.J.Turbine™, W.J.Multi Stage Turbine™, W.J.Micro Turbine™, or W.J.Nano Turbine™; only the engineering details needed to tailor the size and output of a particular turbine to the specific application differentiate alternative embodiments. Thus, additional alternative embodiments relate to adaptation of the turbine assembly to particular applications. The turbine assembly can be adapted for generation of electrical energy, e.g., as a primary turbine in a power generation plant. The turbine assembly can also be adapted for generation of electrical energy for an electric motor of any size.

In other alternative embodiments, the turbine assembly can also be used as the power source for the propulsion of any kind of motor vehicle, the motor vehicle being chosen from the group consisting of automobile, van, pickup truck, sport-utility vehicle, bus, truck, and any other wheeled vehicle used for ground transportation; or in the engine of a tank or other armored vehicle. Similarly, the turbine assembly can be adapted for use in the engine of any type of boat and/or ship and/or hovercraft. In yet another alternative embodiment, the turbine assembly is adapted for use in the engine of a locomotive, whether the locomotive is designed for above-ground or for underground use. In yet other alternative embodiments, the turbine assembly is adapted for providing propulsion to a motorcycle, motorized bicycle, motorized tricycle, or motorized cart by providing the power source to the vehicle's engine. In yet other alternative embodiments, the turbine assembly is introduced as a propulsion system for any type of agricultural vehicle, chosen in a non-limiting manner from the group consisting of thresher, reaper, combine harvester, tractor, and any other vehicle adapted for use in agriculture, thus providing propulsion to the agricultural vehicle. Since the invention disclosed herein can be scaled to any size, it can be used as a micro-turbine as well. Thus, in yet additional alternative embodiments, this micro-turbine is used to provide electrical power to a manufactured item (e.g. a computer) of any size that requires an external source of electricity. In additional alternative embodiments, the turbine assembly can be scaled down even further to the nanoscale, and used as a turbine in any nanoscale machine or device that requires a rotating shaft.

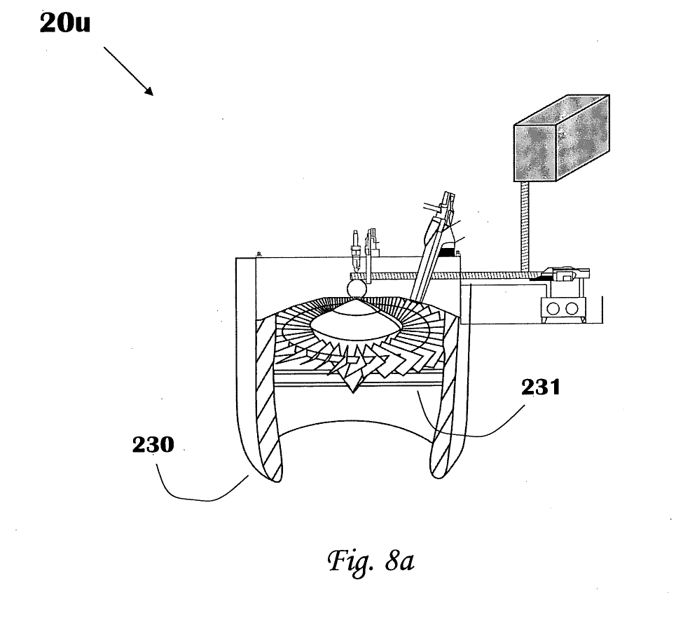

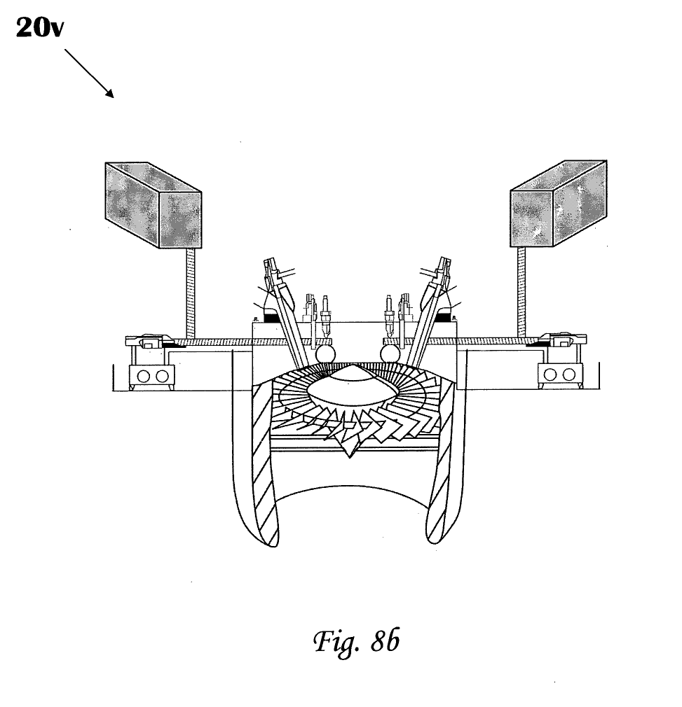

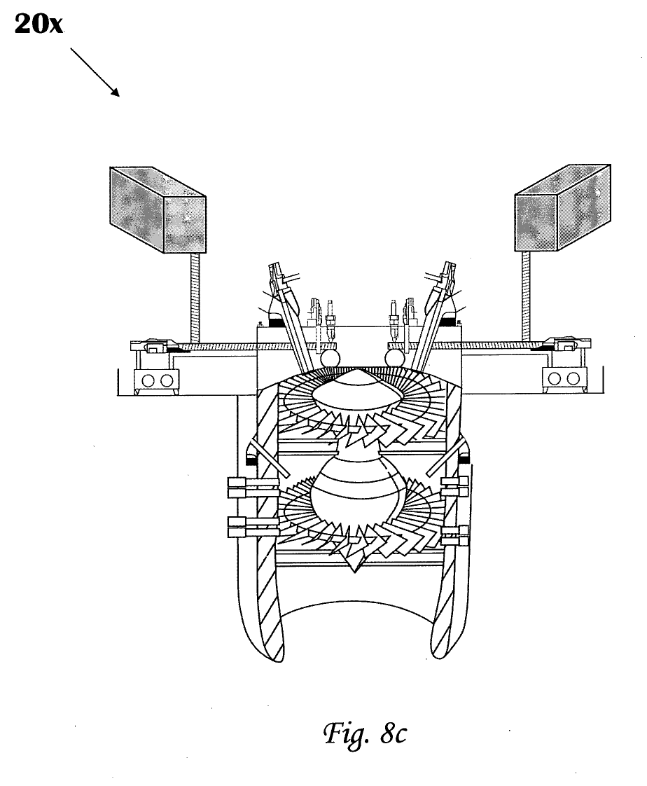

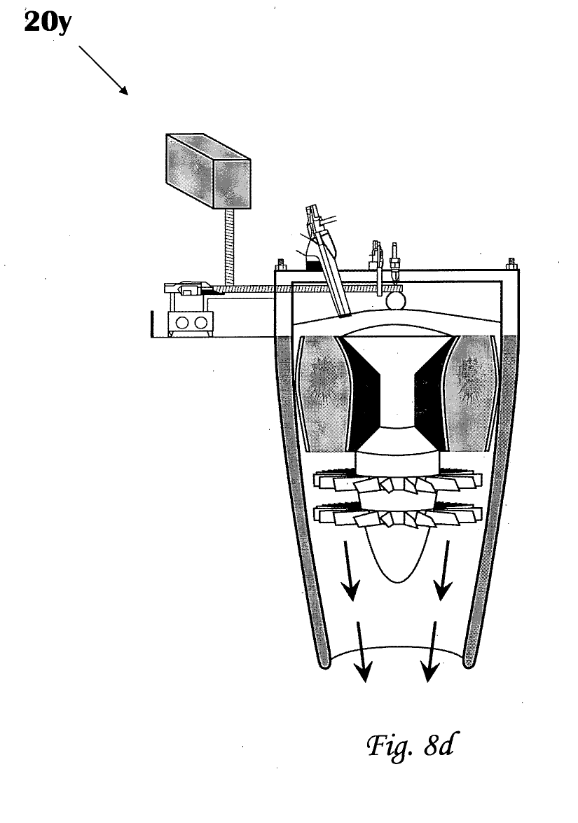

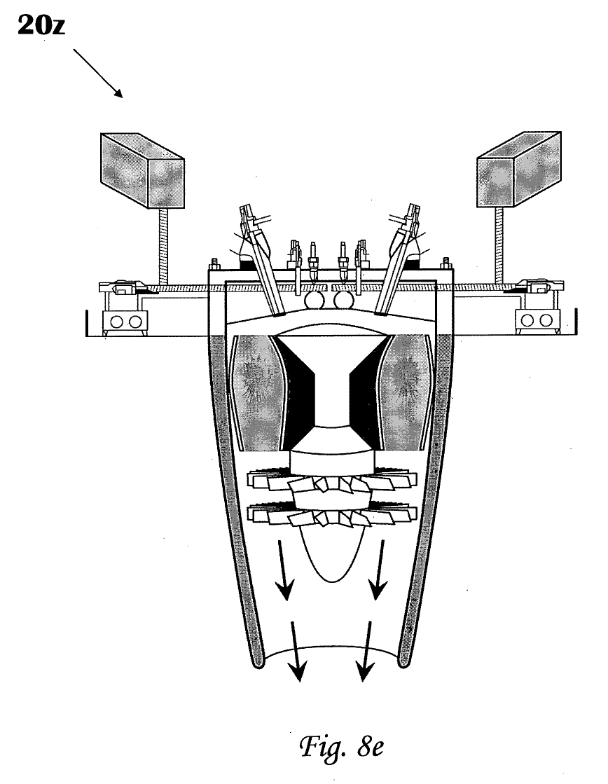

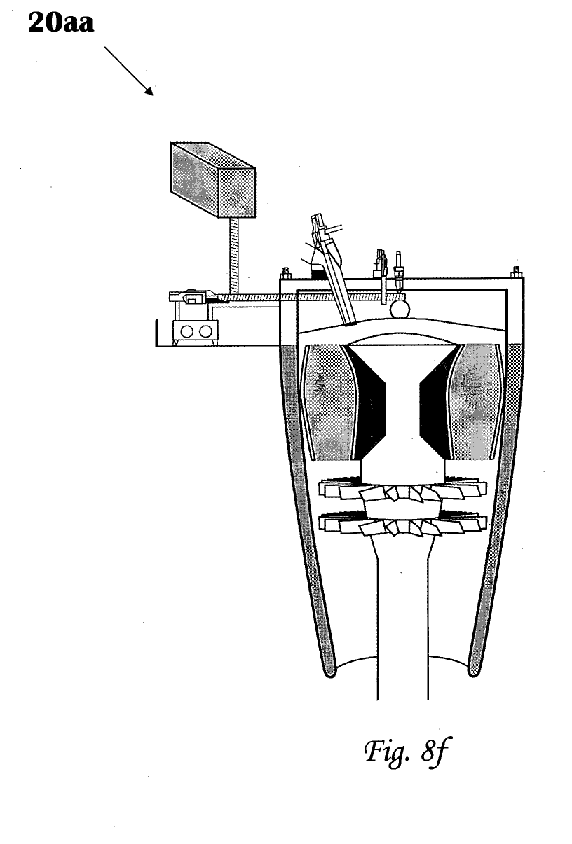

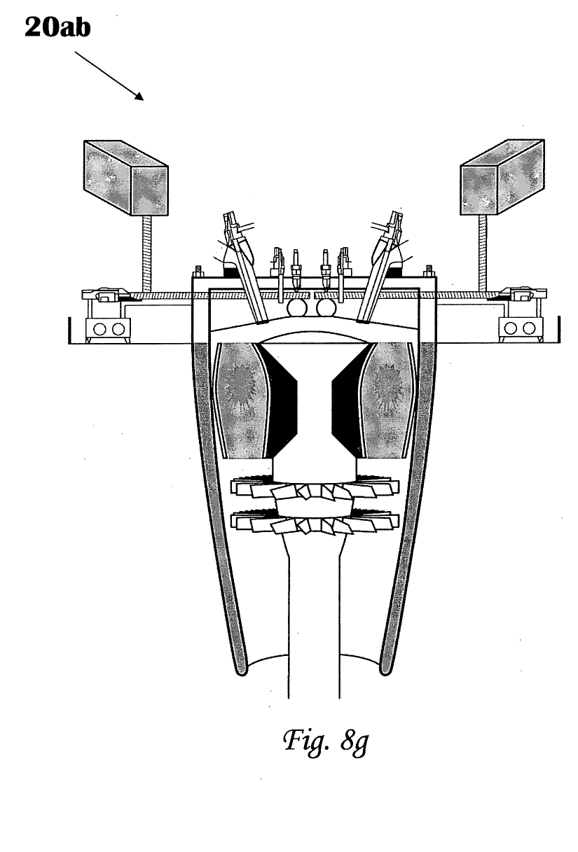

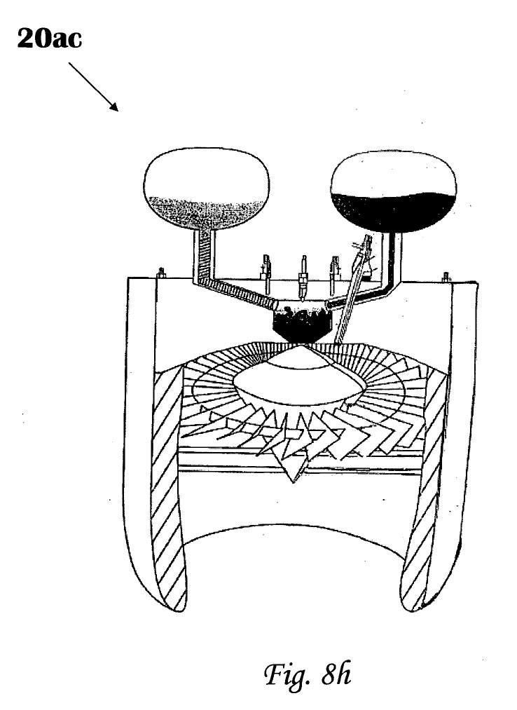

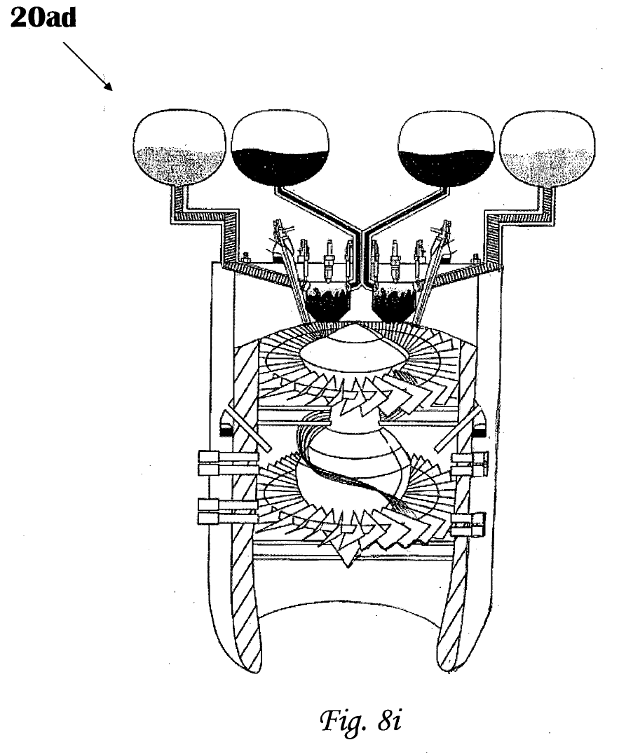

Reference is now made to the group FIG. 8, in which a group of embodiments 20u-20ad exemplifying one such adaptation is presented schematically (not to scale). In this embodiment, the turbine assembly is adapted for use in a jet engine for propulsion, e.g., of an airplane. It is acknowledged and emphasized in this respect that the figure is included for illustrative and exemplary purposes only. It will be obvious to one in the art that alternative embodiments (e.g. differing numbers of rotors and stators, or differing numbers of deflagration chambers) can be designed that differ in details of construction without affecting the essence of the invention. In these embodiments, the turbine assembly housing 200 is modified so that instead of an essentially closed chamber with an exhaust system, the rear of the housing is left open and shaped into a nozzle 230 in order further to increase the velocity of the exhaust and thus to increase the thrust provided by the engine. Some of the details of the turbine assembly must necessary be modified from embodiments adapted, e.g., for generation of electrical power. Thus, rather than a shaft that is supported by the floor of the turbine, the shaft 203 may supported by struts 231 that connect it to the internal walls of the turbine assembly housing, and the shape of the rotor blades will necessarily be adapted to maximize the forward thrust provided by the engine. The simplest such arrangement, with one set of rotor blades, is shown in FIG. 8a (20u, with one deflagration chamber and fuel storage unit) and 8b (20v, with two deflagration chambers and fuel storage units). An alternative embodiment 20x, comprising a two-stage construction in which the second stage comprises a combustion chamber (211), oxidant inlet (212), and ignition means (216), is shown in FIG. 8c.

FIGS. 8d-8g show embodiments 20y-20ab respectively, in which the turbine assembly is constructed as a typical gas turbine of the sort normally found in jet engines, with a plurality of rotors; the arrangement shown in the figures, with two rotors, is for exemplary and illustrative purposes only. It will be obvious to one skilled in the art that the exact number of rotors needed will depend on the specific needs (e.g. total thrust needed) of the particular use. FIGS. 8d and 8f show embodiments 20y and 20aa respectively, which comprise a single fuel storage unit and a single deflagration chamber, while FIGS. 8e and 8g show embodiments 20z and 20ab, respectively, which comprise dual fuel storage units and dual deflagration chambers. Non-limiting examples of possible shaft designs are given in FIGS. 8d and 8e on the one hand and 8f and 8g on the other. FIGS. 8h and 8i show embodiments 20ac and 20ad, in which the gas turbine engine is driven by a dual-component fuel. In the case of FIG. 8h (in which embodiment 20ac is illustrated), a single container of nitrating agent and a single container of cellulose are used to supply the components of the dual-component fuel to a single reaction chamber. FIG. 8i illustrates an embodiment (20ad) in which a multi-stage gas turbine engine is driven by dual-component fuel created and deflagrated in two independent reaction chambers, each of which is supplied by a separate source of cellulose and nitrating agent. It will be obvious to one skilled in the art that in all cases, such details as the number of deflagration chambers and storage units will depend on the specific needs of the particular use to which the embodiment is put.

In yet another alternative embodiment, the turbine is adapted for providing propulsion to any kind of space-going craft.

The advantages of a turbine assembly as disclosed in the present invention are clear: it runs without the necessity of an oxidant; at low temperature; without producing pollutants such as NOₓ and SOₓ; and it can be adapted to any size or power required by the user. In addition, since the turbine assembly disclosed in the present invention is adapted to utilize anaerobic fuel without any need for an external oxidant, it can easily be adapted to operate in environments with low free oxygen, such as at high altitudes, or underground (particularly during such events as rescue operations following, e.g., mine fires). Properly sealed, the turbine assembly disclosed in the present invention can even operate in oxygen-free environments such as outer space or under water.

It is within the scope of the present invention to provide a method for using anaerobic fuel to drive a turbine, said method comprising the steps of (a) obtaining anaerobic fuel; (b) transferring a predetermined quantity of said anaerobic fuel to at least one deflagration chamber; (c) igniting and deflagrating said predetermined quantity of said anaerobic fuel within said deflagration chamber; (d) allowing gases produced by said deflagration to expand into a second chamber, said second chamber containing a shaft and a rotor assembly supported by said shaft; (e) exhausting gases from said second chamber; and) repeating steps (b) through (e). According to this method, the rotor assembly is driven by expansion of gases produced by predetermined deflagration of said anaerobic fuel.

Such a method for using anaerobic fuel that includes the additional step of combusting inflammable gases present in the gas exhausted from the second chamber is additionally provided by the invention disclosed herein.

The invention disclosed herein additionally provides a method for using anaerobic fuel to drive a turbine, said method comprising the steps of (a) obtaining anaerobic fuel; (b) transferring a predetermined quantity of said anaerobic fuel to at least one deflagration chamber according to a predetermined sequence; (c) igniting and deflagrating said predetermined quantity of said anaerobic fuel within said deflagration chamber according to a predetermined protocol; (d) allowing gases produced by said deflagration to expand into a second chamber, said second chamber containing a shaft and a rotor assembly; (e) exhausting gases from said second chamber; and (f) repeating steps (b) through (e). According to this method, expansion of gases produced by predetermined deflagration of said anaerobic fuel is used to drive said rotor assembly.

The invention disclosed herein additionally provides a method for using anaerobic fuel to drive a multi-stage turbine, said method comprising the steps of (a) obtaining anaerobic fuel; (b) transferring a predetermined quantity of said anaerobic fuel to at least one deflagration chamber; (c) igniting and deflagrating said predetermined quantity of said anaerobic fuel within said deflagration chamber; (d) allowing gases produced by said deflagration to expand into a first-stage turbine chamber, said first-stage turbine chamber containing a first-stage shaft and a first-stage rotor assembly supported by said first-stage shaft; (e) exhausting gases from said first-stage turbine chamber; (f) allowing said gases exhausted from said first-stage turbine chamber to flow into an oxidation chamber; (g) allowing an oxidant to flow into said oxidation chamber contemporaneously with the flow of said gases exhausted from said first-stage turbine chamber into said oxidation chamber; (h) combusting inflammable gases contained within said gases exhausted from said first-stage turbine chamber in said oxidation chamber; (i) allowing gases to flow from said oxidation chamber to a second-stage turbine chamber, said second-stage turbine chamber containing a second-stage shaft and a second-stage rotor assembly supported by said shaft; and, (j) repeating steps (b) through (i). According to this method, expansion of gases produced by predetermined deflagration of said anaerobic fuel is used to drive said first-stage rotor assembly, and expansion of gases produced by combustion in the oxidation chamber is used to drive the second-stage rotor assembly.

The invention disclosed herein additionally provides a method for using anaerobic fuel to drive a multi-stage turbine, said method comprising the steps of (a) obtaining anaerobic fuel; (b) transferring a predetermined quantity of said anaerobic fuel to at least one deflagration chamber; (c) igniting and deflagrating said predetermined quantity of said anaerobic fuel within said deflagration chamber; (d) allowing gases produced by said deflagration to expand into a first-stage turbine chamber, said first-stage turbine chamber containing a first-stage shaft and a first-stage rotor assembly supported by said first-stage shaft; (e) exhausting gases from said first-stage turbine chamber; (f) allowing said gases exhausted from said first-stage turbine chamber to flow into an oxidation chamber; (g) allowing an oxidant to flow into said oxidation chamber contemporaneously with the flow of said gases exhausted from said first-stage turbine chamber into said oxidation chamber; (h) combusting inflammable gases contained within said gases exhausted from said first-stage turbine chamber in said oxidation chamber; (i) obtaining liquid water; (j) using heat generated by said combusting of said inflammable gases to heat said water to steam and/or superheated steam; (k) using said steam and/or superheated steam to drive a second-stage steam turbine; and (l) repeating steps (b) through (k). According to this method, expansion of gases produced by predetermined deflagration of the anaerobic fuel is used to drive the first-stage rotor assembly; combustion of the flammable portion of the exhaust from the first stage in the oxidation chamber is used to heat water to steam (alternatively superheated steam) which is used to drive the second-stage steam turbine. An alternative embodiment of this method in the additional steps of (a) allowing said steam and/or superheated steam exiting said steam turbine to flow into a condenser; (b) condensing said steam and/or superheated steam to liquid water; (c) using said condensate as said liquid water, thus enabling the use of the water in a closed loop.

The invention disclosed herein additionally provides a method for generating energy utilizing the deflagration of an anaerobic fuel, comprising the steps of (a) obtaining anaerobic fuel; (b) introducing said anaerobic fuel into a deflagration chamber; (c) igniting and deflagrating said anaerobic fuel within said deflagration chamber; (d) discharging gases formed during the deflagration of said anaerobic fuel across an energy-generating machine; and, (e) repeating steps (b) through (d). The gases produced in the deflagration are thus used to drive the energy-generating machine.

The invention disclosed herein additionally provides a method for generating energy utilizing the deflagration of an anaerobic fuel, comprising the steps of (a) obtaining anaerobic fuel; (b) introducing said anaerobic fuel into a deflagration chamber; (c) igniting and deflagrating said anaerobic fuel within said deflagration chamber; (d) discharging gases formed during the deflagration of said anaerobic fuel across a first energy-generating machine; (e) allowing gases to flow from the exhaust of said first energy-generating machine to an oxidation chamber; (f flowing an oxidant into said oxidation chamber contemporaneously with said flow of exhaust gases; (g) combusting the inflammable portion of said exhaust gases in said oxidation chamber; (h) discharging gases present in said oxidation chamber after combustion of said inflammable portion of said exhaust gases across a second energy-generating machine; and (i) repeating steps (b) through (k. According to this method, the first energy-generating machine is driven by said gases produced in the deflagration, while the second energy-generating machine is driven by gases discharged from the oxidation chamber after combustion of the flammable portion of the exhaust from the first stage.

The invention herein disclosed additionally provides a method for heating a large area or volume. This method is obtained by adding to any of the preceding methods the steps of (a) allowing exhaust gases to flow from the turbine assembly into a closed channel, said closed channel being in thermal contact with a heat exchanger and (b) using the heat exchanger to transfer heat from the exhaust gases to an area or volume external to the turbine assembly.

The invention disclosed herein additionally provides a method for generating energy utilizing the deflagration of an anaerobic fuel, in which the step of obtaining anaerobic fuel further comprises the step of obtaining anaerobic fuel chosen from the group consisting of chemical fuel and propellant.

The invention disclosed herein additionally provides a method for generating energy utilizing the deflagration of an anaerobic fuel, in which the step of obtaining anaerobic fuel further comprises the step of obtaining chemical fuel selected from the group consisting of RDX (C₃H₆N₆O₆), TNT (CH₃C₆H₂(NO₂)₃), HMX, cellulose, nitrocellulose and nitroglycerin.

The invention disclosed herein additionally provides a method for generating energy utilizing the deflagration of an anaerobic fuel, in which the step of obtaining anaerobic fuel further comprises the step of obtaining propellant selected from the group containing compositions of sulfur, ammonium nitrate, ammonium picrate, aluminum powder, potassium chlorate, potassium nitrate (saltpeter), nitrocellulose, pentaerythiotol tetranitrate (PETN), CGDN, 2,4,6 trinitrophenyl methylamine (tetryl) and other booster explosives, a mixture of about 97.5% RDX, about 1.5% calcium stearate, about 0.5% polyisobutylene, and about 0.5% graphite (CH-6), a mixture of about 98.5% RDX and about 1.5% stearic acid (A-5), cyclotetramethylene tetranitramine (HMX), octogen-octahydro-1,3,5,7 tetranitro 1.3.5.7. tetrazocine, cyclic nitramine 2,4,6,8,10,12-hexanitro-2,4,6,8,10,12-hexaazaisowurtzitane (CL-20), 2,4,6,8,10,12-hexanitrohexaazaisowurtzitan (HNIW), 5-cyanotetrazolpentaamine cobalt III perchlorate (CP), cyclotrimethylene trinitramine (RDX), triazidotrinitrobenzene (TATNB), tetracence, smokeless powder, black powder, boracitol, triamino trinitrobenzene (TATB), TATB/DATB mixtures, triethylene glycol dinitrate (TEGDN), tertyl, trimethyleneolethane trinitrate (TMETM), trinitroazetidine (TNAZ), sodium azide, nitrogen gas, potassium oxide, sodium oxide, silicon dioxide, alkaline silicate, salt, saltwater, water from any manmade or natural body of water, diphenylamine, dyestuffs, cellulose, wood, fusel oil, acetobacteria, algae, or any combination thereof.

An additional advantage of the present invention is that the turbine assembly need not be constructed from scratch. Indeed, any existing turbine assembly can be adapted for use with anaerobic fuel. Since the impulse provided by the deflagration of the anaerobic fuel will be in general much higher than that provided by combustion of standard fuels, part of the adaptation will necessarily be a calculation of how many rotor blades and/or rows of blades will be necessary to achieve the same output as the turbine had prior to the adaptation; this number will of course be smaller than that in the existing turbine assembly. The present invention thus additionally provides a method for adapting an existing turbine assembly for use with anaerobic fuel. This method comprises the steps of (a) obtaining a turbine assembly, said turbine assembly comprising a combustion chamber, means for introducing fuel and oxidant into said combustion chamber, and a rotor assembly; (b) replacing the combustion chamber with a deflagration chamber; (c) removing the means for providing oxidant to the combustion chamber; (d) calculating the number of blades and/or rows of blades to be removed from the rotor assembly such that the total power output after the adaptation will match a predetermined value; (e) removing a number of blades and/or rows of blades from said rotor assembly according to the calculation performed in step (d); and, replacing the means for supplying fuel with means for supplying anaerobic fuel. The rotor assembly of the adapted turbine assembly is driven by the predetermined deflagration of anaerobic fuel.

1-56. (canceled)

57. A turbine assembly, comprising:
a. a turbine;
b. means for supplying gas at higher than ambient pressure to one end of said turbine;
c. means for exhausting gas from said turbine, located at the end of said turbine opposite to said one end, said means for exhausting gas being in communication with a region at or below ambient pressure;
wherein said gas at higher than ambient pressure is provided by predetermined deflagration of anaerobic fuel.

58. The turbine assembly of claim 57, further comprising a housing comprising a multiplicity of chambers and wherein:
a. said turbine comprises
i. a shaft contained within one of said chambers within said housing; and,
ii. a rotor assembly supported by said shaft, located within said chamber containing said shaft;
b. said means for supplying gas at higher than ambient pressure to one end of said turbine comprises:
i. at least one deflagration chamber located within said housing, in communication with said chamber in which said shaft and said at least one rotor are located such that gas may pass freely between said deflagration chambers and said shaft;
ii. at least one storage unit for anaerobic fuel;
iii. means for conveying anaerobic fuel from said at least one storage unit to said at least one deflagration chamber; and,
iv. means for igniting said anaerobic fuel within said at least one deflagration chamber;
c. said means for exhausting gases from said turbine are in communication with said chamber containing said shaft and said at least one rotor;
and further wherein rotation of said rotor assembly is driven by motion of gases produced by a predetermined deflagration of said anaerobic fuel from said deflagration chamber to said exhaust.

59. The turbine assembly as in claim 58, said means for conveying said anaerobic fuel to said deflagration chamber comprising:
a. means for connecting said storage unit to said deflagration chamber, said means chosen from the group consisting of tube, pipe, conveyor belt, linear table, screw, plurality of screws, servomotors, pumps, vibrating tables, shaking conveyors, magnets, means for connecting a storage unit for a solid to an enclosed location external to said storage unit;
b. means for extracting a predetermined quantity of fuel from said storage unit;
c. means for enabling physical transfer of said quantity of fuel from said storage unit to said deflagration chamber; and,
d. an isolation valve separating said deflagration chamber from said storage unit, said valve being actuated by means selected from the group consisting of: electrical; pneumatic; hydraulic; and mechanical;
wherein said fuel is safely and accurately conveyed from said storage unit to said deflagration chamber.

60. The turbine assembly as in claim 58, further comprising means for deflagrating inflammable gases contained in the gas emitted from said means for exhausting gases.

61. The turbine assembly as in claim 58, further comprising a heat exchanger adapted to heat exchange between said means for combusting inflammable gases and means for accepting heat transferred from said means for combusting inflammable gases.

62. The turbine assembly as in claim 58, further comprising a second stage, said second stage comprising:
a. an entrance, said entrance communicating with said exhaust means such that gases may freely flow from said exhaust means to said entrance;
b. an oxidation chamber communicating with said entrance such that gases may freely flow from said entrance into said oxidation chamber;
c. means for introducing an oxidant into said oxidation chamber;
d. means for combusting inflammable gases located inside said oxidation chamber;
e. a source of water;
f. means for transferring heat from said oxidation chamber to water derived from said source; and,
g. a second-stage turbine chamber containing a steam turbine in communication with said source of water;
wherein heat generated by combustion of said inflammable gases converts said water to steam, and further wherein said steam turbine is driven by said steam.

63. The turbine assembly of any of claim 58, further comprising a means for diverting exhaust gases from said turbine assembly through a closed channel, said closed channel being in thermal contact with a heat exchanger adapted for changing the temperature of large areas.

64. The turbine assembly of claim 57, in which the means for initiating combustion of said inflammable gases is chosen from the group consisting of a flame; an electric spark; a heating plug or apparatus; a plasma plug; means for initiating combustion of inflammable gases.

65. The turbine assembly as in claim 57, wherein said anaerobic fuel is selected from the group consisting of: a chemical fuel; an anaerobic propellant; RDX (C₃H₆N₆O₆); TNT (CH₃C₆H₂(NO₂)₃); HMX; nitrocellulose; cellulose; nitroglycerin; sulfur; ammonium nitrate; ammonium picrate; aluminum powder; potassium chlorate; potassium nitrate; nitrocellulose; pentaerythiotol tetranitrate (PETN); CGDN; 2,4,6 trinitrophenyl methylamine (tetryl); booster explosives; a mixture of about 97.5% RDX, about 1.5% calcium stearate, about 0.5% polyisobutylene, and about 0.5% graphite (CH-6); a mixture of about 98.5% RDX and about 1.5% stearic acid (A-5); cyclotetramethylene tetranitramine (HMX); octogen-octahydro-1,3,5,7 tetranitro 1.3.5.7. tetrazocine; cyclic nitramine 2,4,6,8,10,12-hexanitro-2,4,6,8,10,12-hexaazaisowurtzitane (CL-20); 2,4,6,8,10,12-hexanitrohexaazaisowurtzitan (HNIW); 5-cyanotetrazolpentaamine cobalt III perchlorate (CP); cyclotrimethylene trinitramine (RDX); triazidotrinitrobenzene (TATNB); tetracence; smokeless powder; black powder; boracitol; triamino trinitrobenzene (TATB); TATB/DATB mixtures; triethylene glycol dinitrate (TEGDN); tertyl, trimethyleneolethane trinitrate (TMETM); trinitroazetidine (TNAZ); sodium azide; nitrogen gas; potassium oxide; sodium oxide; silicon dioxide; alkaline silicate; salt; saltwater; water; diphenylamine; dyestuffs; cellulose; wood; fusel oil; acetobacteria; algae; and combinations thereof.

66. The turbine assembly as in claim 57, wherein said anaerobic fuel comprises at least two components, and further wherein said deflagration chamber is adapted for deflagration of anaerobic fuel prepared in situ from said components.

67. The turbine assembly as in claim 57, wherein said anaerobic fuel is adapted to provide multiple independent deflagrations from each quantity conveyed to said deflagration chamber.

68. The turbine assembly as in claim 57, wherein said anaerobic fuel is in a form selected from the group consisting of: pellet form, pellets comprising a plurality of layers of said anaerobic fuel, capsule form, capsules containing smaller capsules containing anaerobic fuel, solid, gel, flakes, liquid, and powders of any size and shape, and combinations thereof.

69. The turbine assembly as in claim 57, wherein said predetermined sequence is adapted to allow conveyance, ignition, and deflagration of a quantity of said anaerobic fuel while deflagration of a second quantity of said anaerobic fuel is taking place.

70. The turbine assembly of claim 57, adapted for providing propulsion to any kind of space-going craft.

71. A method for using anaerobic fuel to drive a turbine, said method comprising the steps of:
a. obtaining anaerobic fuel;
b. transferring a predetermined quantity of said anaerobic fuel to at least one deflagration chamber;
c. igniting and deflagrating said predetermined quantity of said anaerobic fuel within said deflagration chamber;
d. allowing gases produced by said deflagration to expand into a second chamber, said second chamber containing a shaft and a rotor assembly supported by said shaft;
e. exhausting gases from said second chamber;
f. repeating steps (b) through (e); wherein expansion of gases produced by predetermined deflagration of said anaerobic fuel is used to drive said rotor assembly.

72. The method as in claim 71, further comprising the step of combusting inflammable gases present in said gas exhausted from said second chamber.

73. A method for using anaerobic fuel to drive a multi-stage turbine, said method comprising the steps of:
a. obtaining anaerobic fuel;
b. transferring a predetermined quantity of said anaerobic fuel to at least one deflagration chamber;
c. igniting and deflagrating said predetermined quantity of said anaerobic fuel within said deflagration chamber;
d. allowing gases produced by said deflagration to expand into a first-stage turbine chamber, said first-stage turbine chamber containing a first-stage shaft and a first-stage rotor assembly supported by said first-stage shaft;
e. exhausting gases from said first-stage turbine chamber;
f. allowing said gases exhausted from said first-stage turbine chamber to flow into an oxidation chamber;
g. allowing an oxidant to flow into said oxidation chamber contemporaneously with the flow of said gases exhausted from said first-stage turbine chamber into said oxidation chamber;
h. combusting inflammable gases contained within said gases exhausted from said first-stage turbine chamber in said oxidation chamber;
i. allowing gases to flow from said oxidation chamber to a second-stage turbine chamber, said second-stage turbine chamber containing a second-stage shaft and a second-stage rotor assembly supported by said shaft; and,
j. repeating steps (b) through (i), wherein expansion of gases produced by predetermined deflagration of said anaerobic fuel is used to drive said first-stage rotor assembly, and further wherein expansion of gases produced by combustion in said oxidation chamber is used to drive said second-stage rotor assembly.

74. The method of claim 73 further comprising steps of:
a. obtaining liquid water;
b. using heat generated by said combusting of said inflammable gases to heat said water to steam; and using said steam to drive a second-stage steam turbine;
wherein combustion in said oxidation chamber is used to heat water to steam, and further wherein said steam is used to drive said second-stage steam turbine.

75. A method for using anaerobic fuel to drive a multi-stage turbine, said method comprising the steps of
a. obtaining anaerobic fuel;
b. transferring a predetermined quantity of said anaerobic fuel to at least one deflagration chamber;
c. igniting and deflagrating said predetermined quantity of said anaerobic fuel within said deflagration chamber;
d. allowing gases produced by said deflagration to expand into a first-stage turbine chamber, said first-stage turbine chamber containing a first-stage shaft and a first-stage rotor assembly supported by said first-stage shaft;
e. exhausting gases from said first-stage turbine chamber;
f. allowing said gases exhausted from said first-stage turbine chamber to flow into an oxidation chamber;
g. allowing an oxidant to flow into said oxidation chamber contemporaneously with the flow of said gases exhausted from said first-stage turbine chamber into said oxidation chamber;
h. combusting inflammable gases contained within said gases exhausted from said first-stage turbine chamber in said oxidation chamber;
i. obtaining liquid water;
j. using heat generated by said combusting of said inflammable gases to heat said water to steam;
k. using said steam to drive a second-stage steam turbine; and,
l. repeating steps (b) through (k);
wherein expansion of gases produced by predetermined deflagration of said anaerobic fuel is used to drive said first-stage rotor assembly, and further wherein combustion in said oxidation chamber is used to heat water to, and further wherein said steam is used to drive said second-stage steam turbine.

76. A method for adapting an existing turbine assembly for use with anaerobic fuel, said method comprising the steps of:
a. obtaining a turbine assembly, said turbine assembly comprising a combustion chamber, means for introducing fuel and oxidant into said combustion chamber, and a rotor assembly;
b. replacing the combustion chamber with a deflagration chamber;
c. removing the means for providing oxidant to the combustion chamber;
d. calculating the number of blades to be removed from the rotor assembly such that the total power output after the adaptation will match a predetermined value;
e. removing a number of blades from said rotor assembly according to the calculation performed in step (d); and,
f. replacing the means for supplying fuel with means for supplying anaerobic fuel;
wherein said rotor assembly of said adapted turbine assembly is driven by the predetermined deflagration of anaerobic fuel.
